(19) United States
(12) Patent Application Publication
(10) Pub. No.: US 2026/0051025 A1
(43) Pub. Date: Feb. 19, 2026

(54) Systems and Methods for Video Super Resolution

(71) Applicant: Google LLC, Mountain View, CA (US)

(72) Inventors: Anshul Gupta, Sunnyvale, CA (US); Suyao Ji, Mountain View, CA (US); Fuhao Shi, San Jose, CA (US); Rongqi Qiu, Sunnyvale, CA (US); Peyman Milanfar, Menlo Park, CA (US); Ignacio Garcia-Dorado, Zürich (CH); Irene Zhu, San Francisco, CA (US); Hossein Talebi, San Jose, CA (US); Mauricio Delbracio, Sunnyvale, CA (US)

(21) Appl. No.: 19/296,025

(22) Filed: Aug. 11, 2025

Related U.S. Application Data
(60) Provisional application No. 63/682,786, filed on Aug. 13, 2024.

(51) Int. Cl. G06T 3/4053; G06T 3/4046; G06T 5/20; G06T 5/60; G06T 5/70

(52) U.S. Cl. CPC G06T 3/4053; G06T 3/4046; G06T 5/20; G06T 5/60; G06T 5/70; G06T 2207/10016; G06T 2207/20016; G06T 2207/20081; G06T 2207/20084

(57) ABSTRACT

An example method includes receiving, by a computing device, a plurality of video frames captured at a first resolution. The method also includes applying a trained machine learning model to upscale the plurality of video frames to a second resolution, wherein the second resolution is higher than the first resolution. The method additionally includes applying a gradient blending process to the upscaled plurality of video frames. The method also includes providing the gradient blended and upscaled plurality of video frames.

### CROSS REFERENCE TO RELATED APPLICATIONS

This application claims priority to U.S. Provisional Ser. No. 63/682,786, filed August 13, 13024, the contents of which are incorporated herein by reference in their entirety.

### BACKGROUND

Many modern computing devices, including mobile phones, personal computers, and tablets, include image capture devices, such as still and/or video cameras. The image capture devices can capture images, such as images that include people, animals, landscapes, and/or objects. The captured images may be at different resolutions and in different lighting environments.

### SUMMARY

This application relates to super-resolution models to improve video resolution. The techniques described herein relate to a video super-resolution technology that enables a computing device, including a mobile device such as a smartphone device, to record a video at a lower resolution for better light gathering ability, and subsequently use temporal super-resolution techniques to upscale the video-frames. The upscaled video frames help to achieve the desired goals of high quality digital-zoom and/or higher-resolution for user captured videos.

Applying photo super resolution solutions directly to video is not feasible because of temporal coherence issues. Visible flickers may be observed at high frequency areas. A super resolution model has to guess and generate details that a low-resolution input does not have. The more details the model can generate (and thus generate a sharper frame), the more artifacts/hallucinations may be observed. This trade-off can be a significant issue with machine learning (ML) models regardless of model size and training data size. For example, face and text can be sensitive to hallucinations because users know what to expect. An extra wrinkle line or a letter misspelling generated from the model can be perceptible. Defocused areas may remain blurry where the model needs to learn what to sharpen and what to maintain, assuming a depth map is not available.

Generative adversarial network (GAN) and other generative models can shift the brightness and color from the input frames. This may be undesirable, and it may be preferable to maintain an overall color to be the same as the input frame. Tiling can enable parallel computation to shorten the inference latency. Unlike other models, the input size of a super resolution model can be variable and dependent on the zoom ratio. Proper tiling strategy to manage use cases and tiling intersection handling may be challenging.

Accordingly, there is a need to overcome these technical challenges and generate high resolution videos.

Some models may be temporally stable at high contrast areas because the edge of the input can be highly visible and the edge position at the output can be reliable. However, at edges with intermediate gradients, it can be challenging for a model to learn where the line is. Accordingly, from frame to frame, the model may output the edge at various positions and result in temporal flicker. As described herein, instead of directly encoding the inference result to output videos, one approach may be to analyze the input gradients and blend the inference results with Rapid and Accurate Image Super-Resolution (RAISR or Raisr) so that regions with high frequency edges are leaning towards the inference result, and regions with low gradient can blend towards Raisr. Raisr is a filter-based algorithm that is temporally stable when the input is temporally stable. This way, image sharpness may be enhanced at contrasty edges, keeping the defocused area blurry, and making edges with intermediate gradient less sharp and temporally more stable.

Hallucination may occur when the model is provided with a highly blurry and/or noisy image as input and trained to generate a sharp and clean image. This is like solving a linear equation with two unknowns where the answer is not unique given the limited condition. Making the input image sharper and cleaner during training can make it easier for the model to learn and reduce potential hallucinations at inference. However, this comes with the cost of a blurrier output. This trade-off can be addressed by adding different blurriness/noise during training data augmentation, and a balance can be determined between hallucination and sharpness of the output image. However, for face and text, where users are sensitive to hallucinations, a different strategy may be applied. For example, faces generated from a base model may be detected and replaced with Raisr results. For texts, a similar approach may be used by replacing them with results from a dedicated text SR model.

As described herein, gradient blending may be applied by generating a spatially varying alpha map that blends in image-regions with large gradients. The term “gradient blending” as used herein, generally refers to a technique used in image processing, particularly in super-resolution models, to control texture hallucinations and improve temporal consistency in upscaled videos. Image gradients measure the change in intensity or color across an image. Areas with strong gradients (like edges) indicate high-frequency details, while areas with low gradients are smoother regions. Based on these gradients, an alpha map is created. This map has values that vary across the image, dictating how much the super-resolved output (from a machine learning model) should be blended with a more stable, typically lower-frequency, source like RAISR. Regions with high-frequency edges (strong gradients) are blended more towards the inference result of the super-resolution model, enhancing sharpness. Conversely, regions with low gradients (smoother areas) are blended more towards RAISR, which is temporally stable, thus reducing flicker and noise in these areas. These techniques may be combined with a generative adversarial network (GAN) trained with subsampled-raw enhanced high dynamic range (HDR+) processed bursts and fine-tuned noise augmentation to remove background hallucination artifacts.

In one aspect, a computer-implemented method is provided. The method includes receiving, by a computing device, a plurality of video frames captured at a first resolution. The method also includes applying a trained machine learning model to upscale the plurality of video frames to a second resolution, wherein the second resolution is higher than the first resolution. The method additionally includes applying a gradient blending process to the upscaled plurality of video frames. The method also includes providing the gradient blended and upscaled plurality of video frames.

In another aspect, a system is provided. The system may include one or more processors. The system may also include data storage, where the data storage has stored thereon computer-executable instructions that, when executed by the one or more processors, cause the system to perform operations. The operations may include receiving, by a computing device, a plurality of video frames captured at a first resolution. The operations may also include applying a trained machine learning model to upscale the plurality of video frames to a second resolution, wherein the second resolution is higher than the first resolution. The operations may additionally include applying a gradient blending process to the upscaled plurality of video frames. The operations may also include providing the gradient blended and upscaled plurality of video frames.

In another aspect, a computing device is provided. The device includes a primary camera and a secondary camera that share a common field of view. The device also includes one or more processors and data storage that has stored thereon computer-executable instructions that, when executed by the one or more processors, cause the computing device to perform operations. The operations may include receiving, by a computing device, a plurality of video frames captured at a first resolution. The operations may also include applying a trained machine learning model to upscale the plurality of video frames to a second resolution, wherein the second resolution is higher than the first resolution. The operations may additionally include applying a gradient blending process to the upscaled plurality of video frames. The operations may also include providing the gradient blended and upscaled plurality of video frames.

In another aspect, an article of manufacture is provided. The article of manufacture may include a non-transitory computer-readable medium having stored thereon program instructions that, upon execution by one or more processors of a computing device, cause the computing device to perform operations. The operations may include receiving, by a computing device, a plurality of video frames captured at a first resolution. The operations may also include applying a trained machine learning model to upscale the plurality of video frames to a second resolution, wherein the second resolution is higher than the first resolution. The operations may additionally include applying a gradient blending process to the upscaled plurality of video frames. The operations may also include providing the gradient blended and upscaled plurality of video frames.

In another aspect, a program is provided. The program upon execution by one or more processors of a computing device, causes the computing device to perform operations. The operations may include receiving, by a computing device, a plurality of video frames captured at a first resolution. The operations may also include applying a trained machine learning model to upscale the plurality of video frames to a second resolution, wherein the second resolution is higher than the first resolution. The operations may additionally include applying a gradient blending process to the upscaled plurality of video frames. The operations may also include providing the gradient blended and upscaled plurality of video frames.

In another aspect, a computer-implemented method is provided. The method includes receiving training data comprising a plurality of pairs, each pair comprising of a high resolution ground truth image and a corresponding low resolution version of the high resolution image, the corresponding low resolution version having been generated from the high resolution image by (a) performing downscaling and adding noise, and (b) applying a consistent degradation between the low resolution version and the high resolution ground truth image to reduce artifacts in low frequency portions of the low resolution version. The method also includes training, based on the training data, a machine learning (ML) model to predict an upscaled version of a plurality of video frames captured at a first resolution, wherein the upscaled version is in a second resolution, and wherein the second resolution is higher than the first resolution. The method additionally includes providing the trained ML model.

In another aspect, a system is provided. The system may include one or more processors. The system may also include data storage, where the data storage has stored thereon computer-executable instructions that, when executed by the one or more processors, cause the system to perform operations. The operations may include receiving training data comprising a plurality of pairs, each pair comprising of a high resolution ground truth image and a corresponding low resolution version of the high resolution image, the corresponding low resolution version having been generated from the high resolution image by (a) performing downscaling and adding noise, and (b) applying a consistent degradation between the low resolution version and the high resolution ground truth image to reduce artifacts in low frequency portions of the low resolution version. The operations may also include training, based on the training data, a machine learning (ML) model to predict an upscaled version of a plurality of video frames captured at a first resolution, wherein the upscaled version is in a second resolution, and wherein the second resolution is higher than the first resolution. The operations may additionally include providing the trained ML model.

In another aspect, a computing device is provided. The device includes a primary camera and a secondary camera that share a common field of view. The device also includes one or more processors and data storage that has stored thereon computer-executable instructions that, when executed by the one or more processors, cause the computing device to perform operations. The operations may include receiving training data comprising a plurality of pairs, each pair comprising of a high resolution ground truth image and a corresponding low resolution version of the high resolution image, the corresponding low resolution version having been generated from the high resolution image by (a) performing downscaling and adding noise, and (b) applying a consistent degradation between the low resolution version and the high resolution ground truth image to reduce artifacts in low frequency portions of the low resolution version. The operations may also include training, based on the training data, a machine learning (ML) model to predict an upscaled version of a plurality of video frames captured at a first resolution, wherein the upscaled version is in a second resolution, and wherein the second resolution is higher than the first resolution. The operations may additionally include providing the trained ML model.

In another aspect, an article of manufacture is provided. The article of manufacture may include a non-transitory computer-readable medium having stored thereon program instructions that, upon execution by one or more processors of a computing device, cause the computing device to perform operations. The operations may include receiving training data comprising a plurality of pairs, each pair comprising of a high resolution ground truth image and a corresponding low resolution version of the high resolution image, the corresponding low resolution version having been generated from the high resolution image by (a) performing downscaling and adding noise, and (b) applying a consistent degradation between the low resolution version and the high resolution ground truth image to reduce artifacts in low frequency portions of the low resolution version. The operations may also include training, based on the training data, a machine learning (ML) model to predict an upscaled version of a plurality of video frames captured at a first resolution, wherein the upscaled version is in a second resolution, and wherein the second resolution is higher than the first resolution. The operations may additionally include providing the trained ML model.

In another aspect, a program is provided. The program upon execution by one or more processors of a computing device, causes the computing device to perform operations. The operations may include receiving training data comprising a plurality of pairs, each pair comprising of a high resolution ground truth image and a corresponding low resolution version of the high resolution image, the corresponding low resolution version having been generated from the high resolution image by (a) performing downscaling and adding noise, and (b) applying a consistent degradation between the low resolution version and the high resolution ground truth image to reduce artifacts in low frequency portions of the low resolution version. The operations may also include training, based on the training data, a machine learning (ML) model to predict an upscaled version of a plurality of video frames captured at a first resolution, wherein the upscaled version is in a second resolution, and wherein the second resolution is higher than the first resolution. The operations may additionally include providing the trained ML model.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 is an illustration of front, right-side, and rear views of a digital camera device, in accordance with example embodiments.

FIG. 2 is a diagram illustrating an example processor architecture, in accordance with example embodiments.

FIG. 3 is a block diagram illustrating a super resolution machine learning model, in accordance with example embodiments.

FIG. 4 is a block diagram illustrating an example residual dense block (RDB), in accordance with example embodiments.

FIG. 5 is a diagram illustrating generation of training data, in accordance with example embodiments.

FIG. 6A is an image illustrating text processing, in accordance with example embodiments.

FIG. 6B is another image illustrating text processing, in accordance with example embodiments.

FIG. 7A is an image illustrating text processing, in accordance with example embodiments.

FIG. 7B is another image illustrating text processing, in accordance with example embodiments.

FIG. 8A is an image of an alpha map, in accordance with example embodiments.

FIG. 8B is another image of an alpha map, in accordance with example embodiments.

FIG. 9 is a block diagram illustrating gradient blending, in accordance with example embodiments.

FIG. 10 is a block diagram illustrating an example low frequency (LF) replace, in accordance with example embodiments.

FIG. 11 is a diagram illustrating an example model architecture for Rapid and Accurate Image Super-Resolution (RAISR), in accordance with example embodiments.

FIG. 12A is a diagram illustrating another example model architecture for RAISR, in accordance with example embodiments.

FIG. 12B is another diagram illustrating another example model architecture for RAISR, in accordance with example embodiments.

FIG. 13 is a diagram illustrating training and inference phases of a machine learning model, in accordance with example embodiments.

FIG. 14 depicts a distributed computing architecture, in accordance with example embodiments.

FIG. 15 is a block diagram of an example computing device, in accordance with example embodiments.

FIG. 16 is a flowchart of a method, in accordance with example embodiments.

FIG. 17 is another flowchart of a method, in accordance with example embodiments.

### DETAILED DESCRIPTION

Example methods, devices, and systems are described herein. It should be understood that the words “example” and “exemplary” are used herein to mean “serving as an example, instance, or illustration. ” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be viewed as component aspects of one or more overall embodiments, with the understanding that not all illustrated features are necessary for each embodiment.

### Overview

Flagship smartphones with improved camera sensors and processing capabilities are approaching the imaging capabilities of dedicated cameras. While dedicated camera systems have optical zoom lenses, smartphone cameras do not. Flagship smartphones ship with multiple cameras at different focal lengths and use digital zoom techniques to cover intermediate focal lengths. Digital zoom techniques include the use of remosaic mode for center-crop capture and the application of super-resolution models.

Such digital zoom techniques have been successfully applied for image capture but lead to challenges when applied for video capture. For instance, a combination of remosaic and center-crop mode on modern image sensors can reduce the effective area of a pixel by a factor of 4, leading to the corresponding sensor readout being much noisier. For still images, increasing the exposure time can compensate for the reduced light-gathering ability of smaller sensor-pixels. However, for video-capture, the longest exposure time is dictated by the frame-rate of the video capture (e.g., 33.33 ms for 30 fps video). This can result in corresponding video frames being significantly noisier and limiting their use to only super-bright scenes.

Existing approaches to improving resolution for still images do not transfer to videos. For example, while the application of super-resolution deep-learning models is feasible for still images, application of such models to video increases the computational requirement by an order of magnitude. Applying super-resolution models on videos with millions of pixels can place significant computational and power requirements for model inference on a device that is already maxing out its computational, memory and power budget for recording high resolution video. Accordingly, many smartphones use simple interpolation techniques to upscale videos for digital zoom, leading to suboptimal image quality (IQ). Also, applying deep-learning super-resolution models on video frames in a straightforward manner may not be feasible due to significant temporal issues in the upscaled output.

Furthermore, video sharpness and resolution are significant factors in smartphone video quality. Recording higher resolution video like 8K can involve capturing 4K video, and upscaling the video-frames, or using higher resolution sensors with smaller pixels to record in 8K. The former requires significant processing power, which is not available on a smartphone, while the latter faces similar problems of noisier pixels resulting in video frames lacking detail and often looking worse than a 4K video captured with the same sensor size.

Some smartphone devices use sensor-remosaic for zooming in video, where the device captures a center crop of a high megapixel sensor to provide high-quality zoomed-in frames. But since each individual photosite is noisier, the video quality can degrade significantly in lower light scenes.

Some cameras use multi-frame imaging combined with natural hand-motion of the camera to capture multiple frames and merge them together to capture subpixel level details. Such details can then be enhanced by traditional upscaling algorithms to deliver higher quality digital zoom.

Described herein is a video super-resolution technology that enables a smartphone device to record at a lower resolution for better light gathering ability, then uses temporal super-resolution techniques to upscale the video-frames. The upscaled frames help to achieve the desired goals of high quality digital-zoom and/or higher-resolution for user captured videos.

Training data generation for super-resolution models runs HDR+processing on low-resolution raw images and corresponding high-resolution raw images. Training state-of-the-art super-resolution models with this data results in high IQ super-resolution results during inference due to better domain-match between model training and inference.

At inference time, video frames may be upscaled by a deep-learning video super-resolution (VSR) model that is an order of magnitude larger than super-res zoom photo models on existing smartphones.

Cloud tensor processing units (TPUs) may be used to accelerate the inference of the VSR model to run on, for example, 8.32 MP 4K input, and produce a super-resolution image at 2× or larger scale-factor.

The blending algorithm can merge the super-resolution output frame with traditionally upscaled input-frame to address artifacts that are common in deep-learning based super-resolution models, improve temporal consistency of upscaled frames by reducing fine-grained texture noise, and resolve color and/or brightness shift in the super-resolution model output.

Since the videos may be processed on the cloud, the inference of two super-resolution models may be stacked to achieve sharper output frames for 4× upscaling. The final output of the video-super-resolution pipeline described herein can result in video frames that have increased resolution and details compared to the captured video frame received as input.

### Example Camera Systems

As image capture devices, such as cameras, become more popular, they may be employed as standalone hardware devices or integrated into various other types of devices. For instance, still and video cameras are now regularly included in wireless computing devices (e.g., mobile devices, such as mobile phones), tablet computers, laptop computers, video game interfaces, home automation devices, and even automobiles and other types of vehicles.

The physical components of a camera may include one or more apertures through which light enters, one or more recording surfaces for capturing the images represented by the light, and lenses positioned in front of each aperture to focus at least part of the image on the recording surface(s). The apertures may be of a fixed size or may be adjustable. In an analog camera, the recording surface may be a photographic film. In a digital camera, the recording surface may include an electronic image sensor (e.g., a charge coupled device (CCD) or a complementary metal-oxide-semiconductor (CMOS) sensor) to transfer and/or store captured images in a data storage unit (e.g., memory).

One or more shutters may be coupled to, or positioned near, the lenses or the recording surfaces. Each shutter may either be in a closed position, in which it blocks light from reaching the recording surface, or an open position, in which light is allowed to reach the recording surface. The position of each shutter may be controlled by a shutter button. For instance, a shutter may be in the closed position by default. When the shutter button is triggered (e.g., pressed), the shutter may change from the closed position to the open position for a period of time, known as the shutter cycle. During the shutter cycle, an image may be captured on the recording surface. At the end of the shutter cycle, the shutter may change back to the closed position.

Alternatively, the shuttering process may be electronic. For example, before an electronic shutter of a CCD image sensor is “opened,” the sensor may be reset to remove any residual signal in its photodiodes. While the electronic shutter remains open, the photodiodes may accumulate charge. When or after the shutter closes, these charges may be transferred to longer-term data storage. Combinations of mechanical and electronic shuttering may also be possible.

Regardless of type, a shutter may be activated and/or controlled by something other than a shutter button. For instance, the shutter may be activated by a softkey, a timer, or some other trigger. Herein, the term “capture” may refer to any mechanical and/or electronic shuttering process that results in one or more images being recorded, regardless of how the shuttering process is triggered or controlled.

The exposure of a captured image may be determined by a combination of the size of the aperture, the brightness of the light entering the aperture, and the length of the shutter cycle (also referred to as the shutter length, the exposure length, or the exposure time). Additionally, a digital and/or analog gain (e.g., based on an ISO setting) may be applied to the image, thereby influencing the exposure. In some embodiments, the term “exposure length,” “exposure time,” or “exposure time interval” may refer to the shutter length multiplied by the gain for a particular aperture size. Thus, these terms may be used interchangeably and should be interpreted as possibly being a shutter length, an exposure time, and/or any other metric that controls the amount of signal response that results from light reaching the recording surface.

In some implementations or modes of operation, a camera may capture one or more still images each time image capture is triggered. In other implementations or modes of operation, a camera may capture a video image by continuously capturing images at a particular rate (e.g., 24 frames per second) as long as image capture remains triggered (e.g., while the shutter button is held down). Some cameras, when operating in a mode to capture a still image, may open the shutter when the camera device or application is activated, and the shutter may remain in this position until the camera device or application is deactivated. While the shutter is open, the camera device or application may capture and display a representation of a scene on a viewfinder (sometimes referred to as displaying a “preview frame”). When image capture is triggered, one or more distinct payload images of the current scene may be captured.

Cameras, including digital and analog cameras, may include software to control one or more camera functions and/or settings, such as aperture size, exposure time, gain, and so on. Additionally, some cameras may include software that digitally processes images during or after image capture. While the description above refers to cameras in general, it may be particularly relevant to digital cameras. Digital cameras may be standard-alone devices (e.g., a DSLR camera) or may be integrated with other devices.

Either or both of a front-facing camera and a rear-facing camera may include or be associated with an ALS that may continuously or from time to time determine the ambient brightness of a scene that the camera can capture. In some devices, the ALS can be used to adjust the display brightness of a screen associated with the camera (e.g., a viewfinder). When the determined ambient brightness is high, the brightness level of the screen may be increased to make the screen easier to view. When the determined ambient brightness is low, the brightness level of the screen may be decreased, also to make the screen easier to view as well as to potentially save power. Additionally, the ambient light sensor's input may be used to determine an exposure time of an associated camera, or to help in this determination.

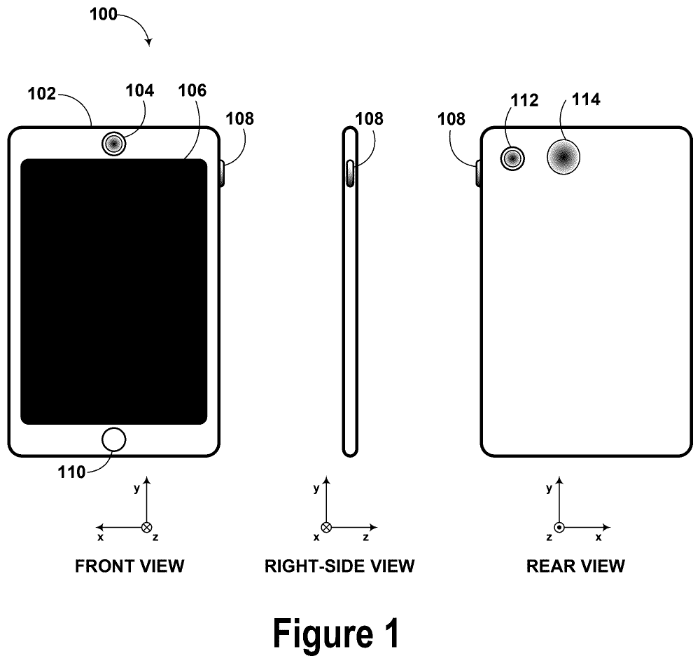

FIG. 1 is an illustration of front, right-side, and rear views of a digital camera device 100, in accordance with example embodiments. Digital camera device 100 may be, for example, a mobile device (e.g., a mobile phone), a tablet computer, or a wearable computing device. However, other embodiments are possible. Digital camera device 100 may include various elements, such as a body 102, a front-facing camera 104, a multi-element display 106, a shutter button 108, and other buttons 110. Digital camera device 100 could further include one or more rear-facing cameras 112, 114. Front-facing camera 104 may be positioned on a side of body 102 typically facing a user while in operation, or on the same side as multi-element display 106. Rear-facing cameras 112, 114 may be positioned on a side of body 102 opposite front-facing camera 104. Referring to the cameras as front-facing and rear-facing is arbitrary, and digital camera device 100 may include multiple cameras positioned on various sides of body 102.

Multi-element display 106 could represent a cathode ray tube (CRT) display, a light-emitting diode (LED) display, a liquid crystal display (LCD), a plasma display, or any other type of display known in the art. In some embodiments, multi-element display 106 may display a digital representation of the current image being captured by front-facing camera 104 and/or rear-facing cameras 112, 114, or an image that could be captured or was recently captured by either or both of these cameras. Thus, multi-element display 106 may serve as a viewfinder for either camera. Multi-element display 106 may also support touchscreen and/or presence-sensitive functions that may be able to adjust the settings and/or configuration of any aspect of digital camera device 100.

Multi-element display 106 may include additional features related to a camera application. For example, multiple modes may be available for a user, including motion mode, portrait mode, portrait mode, video mode, video bokeh mode, and so forth. The camera application may be in camera mode and provide additional features, such as a reverse icon to activate reverse camera view, a trigger button to capture a previewed image, and a photo stream icon to access a database of captured images. Also, for example, a magnification ratio slider may be displayed, and a user can move a virtual object along the magnification ratio slider to select a magnification ratio. In some embodiments, a user may use the multi-element display 106, also referred to herein as the display screen, to adjust the magnification ratio (e.g., by moving two fingers on display screen in an outward motion away from each other), and magnification ratio slider may automatically display the magnification ratio.

Front-facing camera 104 may include an image sensor and associated optical elements such as lenses. Front-facing camera 104 may offer zoom capabilities or could have a fixed focal length. In other embodiments, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent a monoscopic, stereoscopic, or multiscopic camera. Rear-facing cameras 112, 114 may be similarly or differently arranged. Additionally, front-facing camera 104, rear-facing cameras 112, 114, or both, may be an array of one or more cameras.

Either or both of front-facing camera 104 and rear-facing cameras 112, 114 may include or be associated with an illumination component that provides a light field to illuminate a target object. For instance, an illumination component could provide flash or constant illumination of the target object (e.g., using one or more LEDs). An illumination component could also be configured to provide a light field that includes one or more of structured light, polarized light, and light with specific spectral content. Other types of light fields known and used to recover three-dimensional (3D) models from an object are possible within the context of the embodiments herein.

In some digital camera devices 100, either or both of front-facing camera 104 and rear-facing cameras 112, 114 may include or be associated with an ambient light sensor that may continuously or from time to time determine the ambient brightness of a scene that the camera can capture. In some devices, the ambient light sensor can be used to adjust the display brightness of a screen associated with the camera (e.g., a viewfinder). When the determined ambient brightness is high, the brightness level of the screen may be increased to make the screen easier to view. When the determined ambient brightness is low, the brightness level of the screen may be decreased, also to make the screen easier to view as well as to potentially save power. Additionally, the ambient light sensor's input may be used to determine an exposure time of an associated camera, or to help in this determination.

Digital camera device 100 could be configured to use multi-element display 106 and either front-facing camera 104 or rear-facing cameras 112, 114 to capture images of a target object (e.g., a subject within a scene). The captured images could be a plurality of still images or a video image (e.g., a series of still images captured in rapid succession with or without accompanying audio captured by a microphone). The image capture could be triggered by activating shutter button 108, pressing a softkey on multi-element display 106, or by some other mechanism. Depending upon the implementation, the images could be captured automatically at a specific time interval, for example, upon pressing shutter button 108, upon appropriate lighting conditions of the target object, upon moving digital camera device 100 a predetermined distance, or according to a predetermined capture schedule.

As noted above, the functions of digital camera device 100 (or another type of digital camera) may be integrated into a computing device, such as a wireless computing device, cell phone, tablet computer, laptop computer, and so on. For example, a camera controller may be integrated with the digital camera device 100 to control one or more functions of the digital camera device 100.

### Example Video Super Resolution

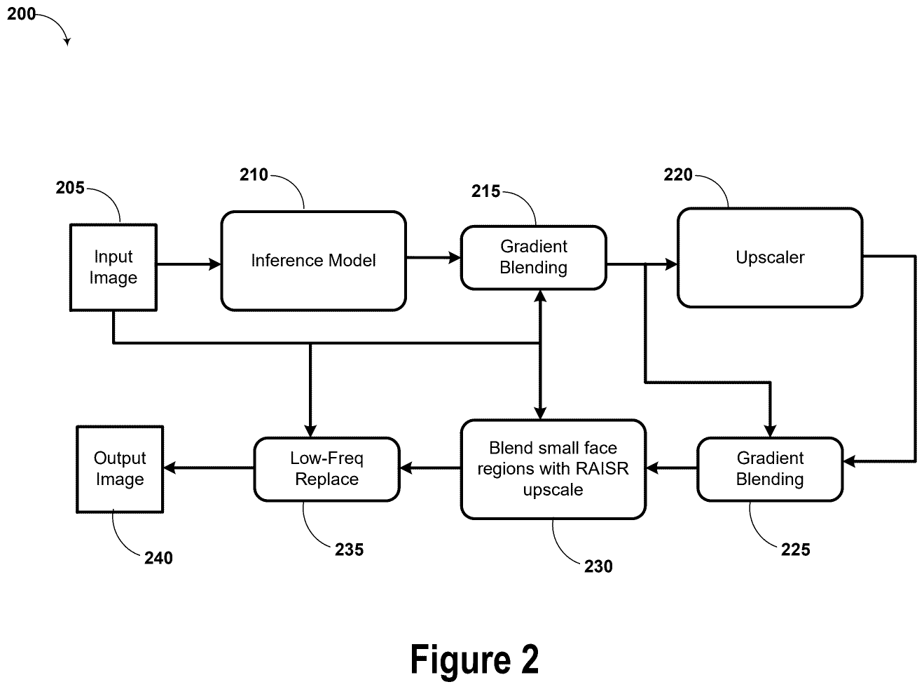

FIG. 2 is a diagram illustrating an example processor architecture 200, in accordance with example embodiments. A low frequency (LF)-replace block may be configured that computes the RGB difference between input and output in a downsampled domain, upscales it, and adds the delta to the output to align the final output with the input brightness and color. The components include an inference model 210 (e.g., 2× Super resolution GAN model), gradient blending blocks 215 and 225, face region blending block 230, and low frequency replace block 235.

Input image 205 may be provided to inference model 210. The inference model 210 may be a generative adversarial network (GAN) model that focuses on upscaling images by a factor of 2. For example, a deep neural network (DNN) model may be based on a GAN model, which uses Residual-in-Residual Dense Block (RRDB) blocks with a modified loss function.

The inference model 210 (e.g., deep neural network (DNN) model) may be based on a GAN model. In some embodiments, the GAN model architecture can use 64 channel feature maps and 15 RRDB blocks. In some embodiments, GAN may utilize RRDB blocks with a modified loss. For example, a GAN may be configured with RGB_L1_Unsharp+VGG_loss+Relativistic_Discriminator_loss. As another example, a GAN may be configured with YUV_L1+VGG_Unsharp_loss+Relativistic_Discriminator_loss. Here, unsharp refers to applying unsharp-mask operation on target image before computing loss. YUV_L1 involves converting the RGB output & target images to YUV space and then computing L1 loss.

Gradient blending block 215 may apply a gradient blending process to an output of inference model 210. Gradient blending block 215 may utilize a spatially varying alpha-blending algorithm.

The output of gradient blending block 215 may be provided to upscaler 220 (e.g., Rapid and Accurate Image Super-Resolution (RAISR) component). The output of gradient blending block 215 and upscaler 220 may be provided to gradient blending block 225. Additional gradient blending may be performed by gradient blending block 225. The purpose of the gradient-blending block 215 is to control texture hallucinations, particularly in low-frequency regions, by blending the output of inference model 210 with the input image 205 based on image gradients. The output of gradient blending blocks 215 and 225 may be provided to face region blending block 230.

The face region blending block 230 is designed to manage face and text areas, which are sensitive to hallucinations. For faces, the faces generated by inference model 210 may be detected and replaced with results from upscaler 220 to improve quality.

The output of the face region blending block 230 may be provided to low-frequency replace block 235, which addresses color and brightness shifts that can occur in the output of the inference model 210. The low-frequency replace block 235 computes the RGB difference between the input and output in a downsampled domain, upscales it, and adds this delta to the output to align the final brightness and color of the output image 240 with the input image 205.

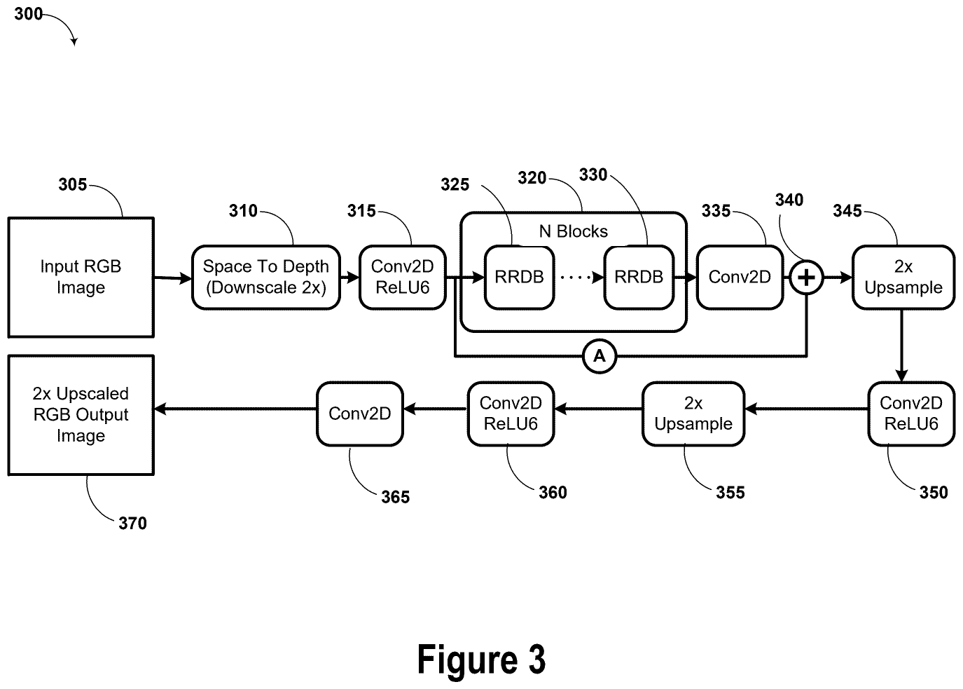

FIG. 3 is a block diagram illustrating a super resolution machine learning model 300, in accordance with example embodiments. Each Residual-in-Residual Dense Block (RRDB) may include three (3) Residual Dense Blocks (RDBs) in series. The output of the final RDB block may be added to the RRDB input tensor.

Input Image 305 may be a low-resolution input image (e.g., RGB image). The input image 305 may be downscaled by a space-to-depth block 310. The downscaled version may pass through a two-dimensional convolutional (Conv2D) layer 315. The output of the Conv2D layer 315 then feeds into a series of RRDBs 320, such as a first RRDB 325, an N-th RRDB 330, etc. In some embodiments, there may be 15 RRDBs. After the RRDB blocks, the data goes through a second Conv2D layer 335 and an upsampling process 345. Following upsampling process 345, there may be a third Conv2D layer 350. Following a second upsampling process 355, there may be a fourth Conv2D layer 360 and a fifth Conv2D layer 365. The output is the super-resolved (SR) image 370.

A direct connection A indicates how the output of the initial Conv2D layer 315 is added by an adder circuitry 340 to the output of the second Conv2D layer 335 prior to upsampling 345, indicating a residual connection where the features from earlier layers are added to later layers. In SR architectures, this helps with stable training and information flow.

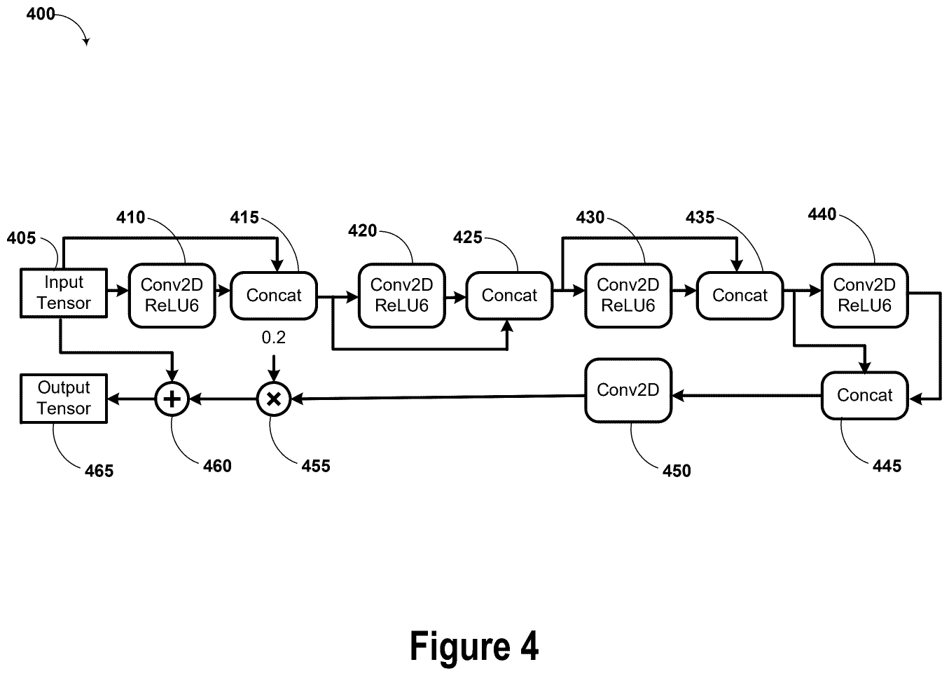

FIG. 4 is a block diagram 400 illustrating an example residual dense block (RDB), in accordance with example embodiments. Each RDB block may include N Conv2D blocks such as 410, 420, 430, 440, . . . 450 (with N=5), connected such that the final Conv2D layer 450 (or the N-th Conv2D layer) receives the concatenated outputs of all previous N−1 Conv2D layers, creating a dense connection between the Conv2D blocks. The final Conv2D layer 450 is without activation and maps the concatenated outputs to input num-channels for final residual connection. Conv2D layer 450 is configured to aggregate the learned features from the dense block before the residual connection is applied.

In some embodiments, the inference model can use 64 channel feature maps and 15RRDB blocks. In some embodiments, Relu6may be used as an activation function instead of Leaky_Relu. The discriminator may be a U-Net model. In some embodiments, a 2× model inference can have 10,947,781 parameters.

The input tensor 405 is the initial input to the RDB. In the context of the Super-Res Processor Architecture, this would be the feature maps coming from the previous block (either the initial Conv2D layer or another RDB/RRDB block).

In some embodiments, the RDB can include four sequential Conv2D ReLU6 blocks such as 410, 420, 430, 440. Each of these blocks such as 410, 420, 430, 440 represents a convolutional layer followed by a Rectified Linear Unit 6 (ReLU6) activation function. The ReLU6 function is a variant of ReLU that clamps the output values (e.g., between 0 and 6) , which can be useful for reducing potential saturation issues in certain contexts.

Between each Conv2D ReLU6 block (except the last Conv2D block 450), there is a Concat operation such as 415, 425, 435, 445. This indicates a dense connection where the output of each preceding Conv2D ReLU6 block is concatenated with the original input tensor, and potentially the outputs of earlier Conv2D ReLU6 blocks within the same RDB. Each RDB block can contain five (5) Conv2D blocks, connected such that the N-th Conv2D layer receives the concatenated outputs of all previous N−1 Conv2D layers, creating a dense connection between the conv blocks. This dense connectivity allows features from all preceding layers to be reused, promoting information flow and alleviating the vanishing-gradient problem.

The output of the last Concat operation 445 feeds into a final Conv2D block 450. Notably, this final Conv2D block 450 is shown without an activation function (e.g., like ReLU6). For example, the final Conv2D block 450 is without activation and maps the concatenated outputs to input num-channels for final residual connection. This final Conv2D block 450 effectively consolidates the features from the densely connected paths.

The output of the final Conv2D block 450 is then added by adder circuitry 460 to the original input tensor 405. This is a residual connection, where the learned “residual” information from the RDB is added back to the original input tensor 405. This improves training stability and performance, especially in very deep networks. The result of this addition is the output tensor 465 of the RDB.

In some embodiments, there may be a “0.2” multiplier circuitry 455 connected to the output of the final Conv2D block 450 before it is added to the input tensor 1505 by adder circuitry 460. This indicates a weighted residual connection, where the contribution of the RDB's learned features is scaled by 0.2 before being added back. This scaling factor can be a learned parameter or a fixed hyperparameter, often used to control the flow of information or to prevent features from becoming too large.

### Training Data

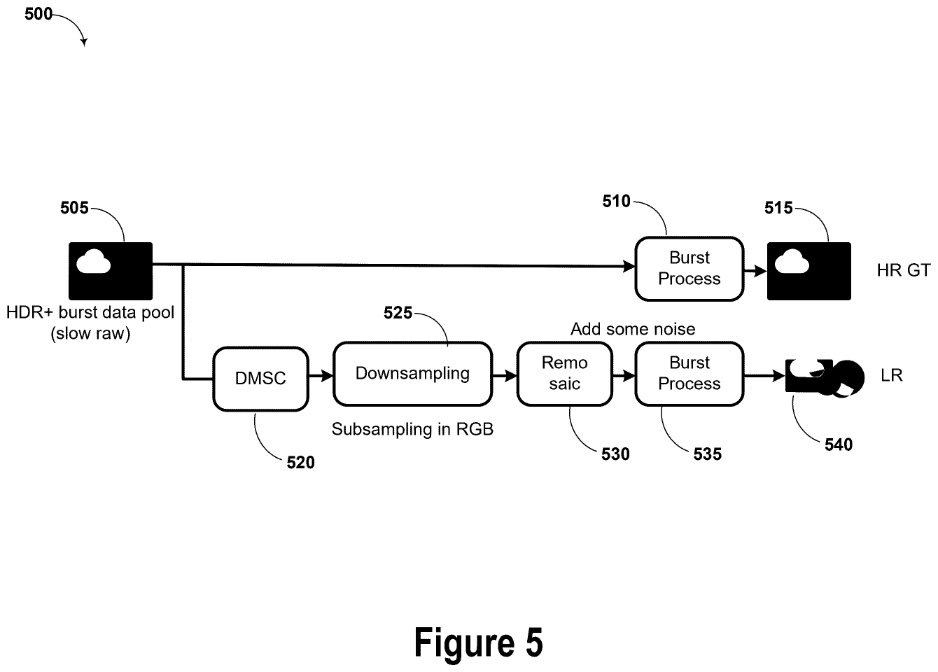

FIG. 5 is a diagram illustrating generation of training data 500, in accordance with example embodiments. In some embodiments, subsampled raw image sets may be used from an enhanced HDR (e.g., HDR+) burst collection 505. Instead of downscaling the full-resolution, HDR+ outputs may be merged to generate low-resolution (LR) images, the individual raw images may be downscaled as part of training data generation. The raw burst data 505 undergoes a demosaic process. Demosaicing is the digital image process of converting raw pixel data from an image sensor (which typically uses a color filter array like a Bayer filter) into a full-color image. The term “raw” as used herein indicates that these are raw sensor data before extensive processing. After demosaicing, a downsampling step occurs. This reduces the resolution of the image. For example, for a given set of High Resolution (HR) raw images, the raw image may be downscaled to generate a lower resolution raw image (downscaling factor=k). The subsampling in RGB step further processes the data, for example, by subsampling the RGB channels. For example, high resolution (HR) Bayer raw data may undergo an HDR+ demosaic operation and then be converted to HR RGB raw data. As another example, HR RGB raw data may be downscaled by a factor of k (k=2/3/4) and then to low resolution (LR) RGB raw data. Also, for example, LR RGB raw may undergo a Remosaic operation and then be converted to LR Bayer raw data.

Non-RGGB Bayer raw data may result in small pixel-shifts between LR and HR raw images. For example, the HDR+and Demosaic operation may crop the first row and/or column of input raw image to convert to RGGB Bayer order.

To address the content shift, the HR raw image may be cropped such that it corresponds to RGGB (or Quad-RGGB) Bayer order, the dimensions of cropped raw image may be integer multiples of k, and when remosaicing the LR RGB raw image, remosaic to RGGB (or Quad-RGGB) Bayer order. This addresses the pixel shift in downscaled raw image.

After addressing the subpixel shift in subsampled raw, the corresponding HDR+results may display noticeable color differences between HR and LR images. This may be addressed by converting the HR raw data to 14-bit unsigned levels before subsampling. The corresponding HDR+ pair is now spatially aligned and has close colors and brightness. To address the reduced noise in LR raw image due to averaging of pixels in downscale, the original sensor-level noise may be added back based on the recorded noise model in the raw image metadata. In some embodiments, additional noise may be added based on a randomly sampled noise model from camera noise model overrides.

Following the downsampling and subsampling, a burst process may be applied. This refers to the processing of the burst of raw images to generate a composite image, similar to how HDR+ processing combines multiple exposures. A heavy denoiser may be enabled for both LR and HR burst process runs.

Referring to FIG. 5, there may be two parallel paths. One path leads from HDR+ burst data pool 505 to the HR ground truth (GT) output 515 after a burst process 510. HR GT output 515 represents the high-resolution, ideal version of the image that the super-resolution model aims to achieve. Instead of downscaling the full-resolution, merged HDR+ outputs to generate low-resolution images, the individual raw-images from HDR+ burst data pool 505 may be downscaled as part of training data generation. The other path leads to the LR output 540, which is the low-resolution input image that will be fed into the super-resolution model during inference. This LR image 540 is derived from the downsampled and processed raw data.

For example, a Dynamic Multi-Scale Convolution or Deep Multi-Scale Context (DMSC) 520 component may be used to enhance the capabilities of the inference model in image analysis. DMSC 520 allows networks to capture features at various scales and adaptively utilize global context for improved feature representation. A downsampling operation 525 may be applied, followed by a remosaic operation 530. Remosaic operation 530 is the inverse of demosaicing, converting the full-color RGB data back into a raw Bayer pattern, which might be necessary for specific subsequent processing steps or for consistency with the raw input format. Noise may be added prior to burst process 535, resulting in LR output 540.

A python script that fetches the raw bursts and runs digital negative (DNG)-subsample followed by paired-HDR+ in parallel may be used. Also, for example, a C++ flume pipeline that takes a list of raw burst-paths as input and directly generates the full-resolution image super resolution (ISR) pair data as output may be used. The data may be shuffled, randomly cropped to 512×512 (˜40 to 50 crops per ISR pair) and stored in a table using a python flume pipeline.

The table generation pipeline determines an L1_difference between an upscaled_LR_crop, and an HR_crop and filters out any crops with anomalously high delta. If average delta is smaller than a threshold value, the probability of such crops being selected may be decreased. By using a consistent degradation between LR 540 and HR GT 515, the corresponding inference model (e.g., GAN model) may be trained not to hallucinate details in low-frequency regions of the image. The model is also more consistent with texture insertion.

One or more augmentations may be applied during DNG subsampling at downscaling block 525. Sensor shot and read noise may be added on subsampled raw image based on captured analog and digital gain values. One noise-model may be randomly picked from pixel tuning overrides. An analog-gain value may be randomly picked, shot and read noise may be added based on the selected noise model and analog gain value for all subsampled raw images in the provided DNG-set. The noise model for the LR raw may be accordingly updated.

Directly connected to the lower LR path, the noise addition component (between remosaic 530 and burst process 535) indicates that noise is intentionally added to the low-resolution image. To address the reduced noise in LR raw image due to averaging of pixels during downscale, the original sensor-level noise may be added back based on the recorded noise model in the raw-image's metadata. In some embodiments, additional noise may be added based on a randomly sampled noise-model from camera noise-model overrides. This makes the training data more robust and helps the model learn to manage noisy real-world inputs.

Augmentations may be applied after a paired-HDR+ call. For example, random Gaussian noise may be added after LR HDR+ with 10% probability and random sigma from [0.001, 0.025]. This augmentation can result in a notable improvement in texture-noise trade-off for the model.

Augmentations may be applied during table generation. For example, a random crop generation with sliding crop-window in raster order may be applied. Crops with large delta between upscaled_LR_crop and HR_crop may be filtered out. A probability of low delta crops (corresponding to blurry input) being selected may be reduced. Once crops are generated, the additional augmentations may be conducted independently for each crop pair, such as, for example, a random rotate in [0, 90, 180, 270] degrees, and a random vertical and horizontal flip. The resulting ISR crop pair is then saved in the table.

Augmentations may be applied during training. The data augmentations may be designed to be stateless to be perfectly repeatable for a given input seed. Random Number Generator (RNG) seeds may be sequentially generated for each image in the dataset, which may then be concatenated with the table data in a data loader. The augmentation function receives the ISR image pair along with the RNG seed tensor, which is used to control augmentation functions such as, for example, a random hue (e.g., Hue delta between [−0.3, 0.3]), a random saturation (e.g., saturation factor between [0.6, 1.4]), a random gamma (e.g., gamma between [0.6, 1.8], a gain between [0.8, 1.2]), a random brightness (e.g., brightness delta between [−0.3, 0.2]), a random contrast (e.g., contrast factor between [0.8, 1.6]), a random noise (e.g., Gaussian noise added in YUV domain), a random JPEG-compression noise (e.g., JPEG quality between [60, 100]), and the input image is quantized to 8-bit levels after augmentation steps and renormalized to [0, 1] fp32.

FIG. 5 depicts a designed pipeline for generating paired high-resolution ground truth, HR GT 515, and low-resolution noisy input images, LR 540, from HDR+ burst raw data 505, which is significant for training a robust super-resolution model. The inclusion of noise addition and specific downsampling/subsampling steps highlights an effort to create realistic training examples that account for real-world image degradation.

### Text Handling

An object-based solution, Text Super Resolution (Text-SR) module, may be designed to restore text details from low-resolution images. In some embodiments, the Text-SR module can include two components: a trigger to detect the texts and a text-SR model to restore and enhance the texts. To integrate into the Video Super Resolution (VSR) module, Text-SR result may be blended with the base model result. In some embodiments, a thread-safe implementation may be used.

The parameters of the Text-SR module may be tuned. For example, reducing input Gaussian blur sigma from 2.0 to 0.5 increases sharpness. The base inference model works well for visible texts, and the Text-SR module helps on barely visible small texts.

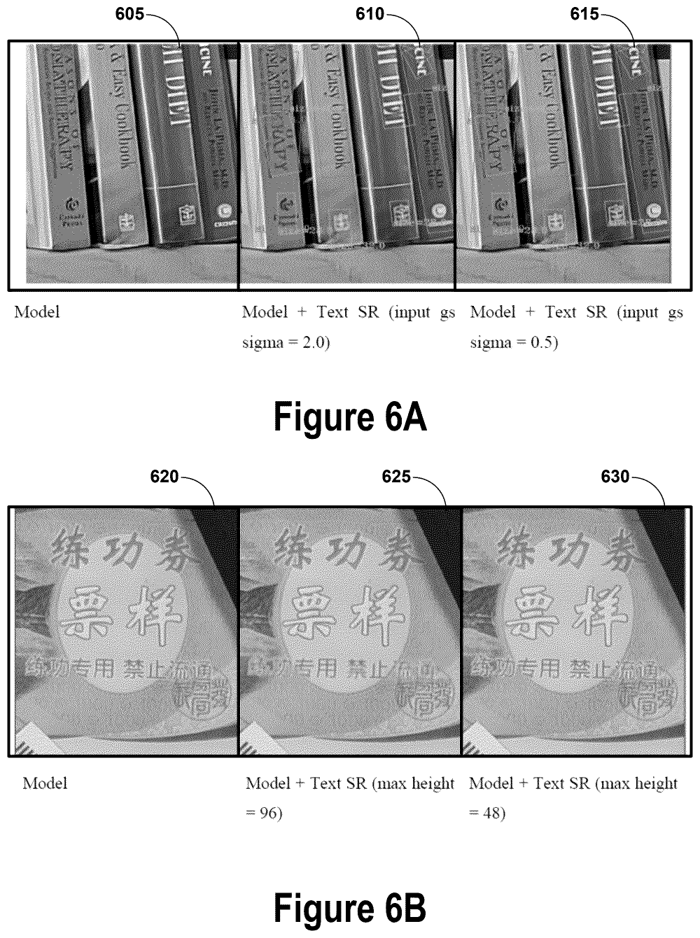

FIG. 6A is an image illustrating text processing, in accordance with example embodiments. FIG. 6A displays three images, arranged horizontally, demonstrating the impact of a Text-SR module on text quality, specifically with different input Gaussian blur sigma values. All three images are a collection of books. Image 605 serves as the baseline, representing the output of the core super-resolution model without the dedicated Text-SR enhancement. The text, particularly the smaller characters, appears blurry and less defined. For instance, the English text “ONLATILERAPY” and “JOHN LA PLIMA, M.D.” shows some blurring, making it slightly harder to read clearly. The overall image quality for the non-textual elements (like the background pattern or graphical elements) seems good, but the text is the primary focus of the comparison.

Image 610 shows the result when the Text-SR module is applied, with an input Gaussian blur sigma of 2.0. Compared to the model image 605, there is a noticeable improvement in text sharpness and clarity. The edges of the characters are more defined, and the text is easier to read.

As indicated herein, reducing input Gaussian blur sigma from 2.0 to 0.5 increases sharpness. Image 615 shows the result when the Text-SR module is applied, with a reduced input Gaussian blur sigma of 0.5. As expected, this image 615 exhibits the sharpest text among the three images. The characters are crisp, and fine details, especially in the smaller characters, are much more distinct. This comparison effectively illustrates that tuning the input Gaussian blur sigma within the Text-SR module can significantly enhance text readability, with a lower sigma value leading to a sharper text.

FIG. 6B is another image illustrating text processing, in accordance with example embodiments. FIG. 6B presents three images, also arranged horizontally, to demonstrate the impact of the Text-SR module, this time specifically focusing on how a maximum text height parameter affects the output. These images appear to be portions of a document containing Chinese text.

Image 620 is the baseline image, representing the output of the core super-resolution model without specific Text-SR enhancement for text height. The text exhibits a certain level of blurriness. For instance, the Chinese characters “ [symbol] ” are indistinct, making them harder to read clearly. This image 620 serves as the control to compare the effects of the Text-SR module with different maximum text height (max_text_height) parameter settings.

Image 625 shows the result when the Text-SR module is applied with max_text_height set to 96. This parameter defines the maximum pixel height of text characters that the Text-SR module will attempt to enhance. A value of 96 is designed to manage large text. Compared to the model image 620, there is a clear improvement in the sharpness and clarity of the text. The Chinese characters appear more defined and legible.

Image 630 displays the outcome when the Text-SR module is used with max_text_height reduced to forty-eight. This setting would effectively tell the Text SR module to bypass or ignore text elements larger than 48 pixels in height. Comparing this to the middle image 625, the large Chinese characters (“ [symbol] ”) show a noticeable degradation in sharpness; they appear blurrier than in the max_height=96 case. This is because the Text-SR module is no longer processing these larger characters. Conversely, smaller text elements (like the fine print) might still benefit from the Text-SR if they fall within the 48-pixel height limit or if the general model still contributes. However, the most evident effect is on the larger text.

FIG. 6B effectively demonstrates that the max_text_height parameter in the Text SR module controls which text sizes are processed for enhancement. Setting a higher max_text_height (e.g., 96) allows the module to sharpen larger text, while a lower setting (e.g., 48) will cause larger text to be bypassed by the Text-SR module, resulting in them remaining blurrier as processed by the base model. This highlights the module's ability to selectively apply text enhancement based on character size.

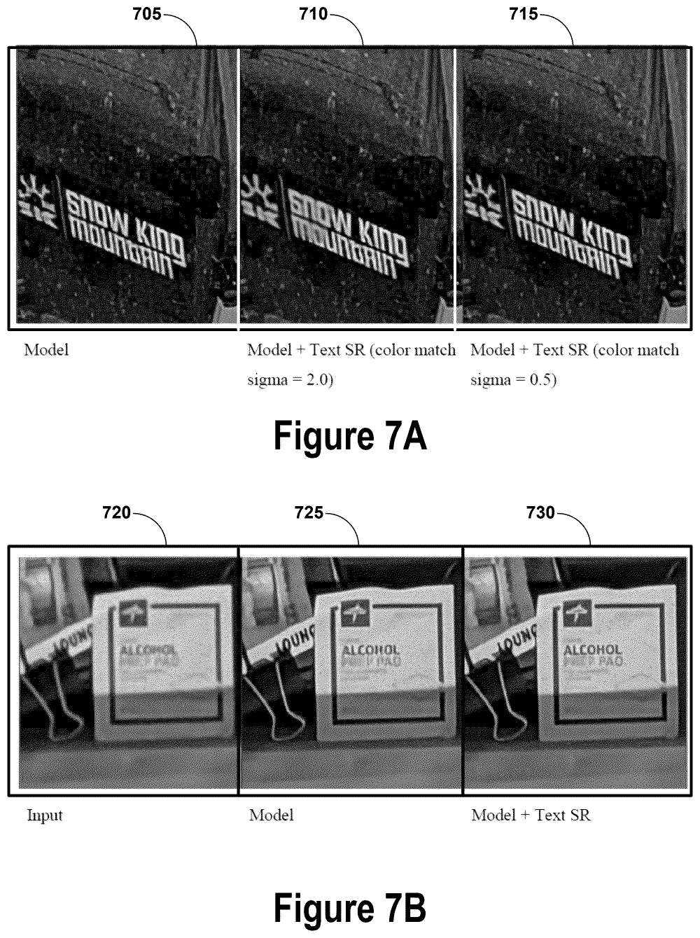

FIG. 7A is an image illustrating text processing, in accordance with example embodiments. FIG. 7A displays three images, arranged horizontally, focusing on the impact of the Text-SR module, specifically demonstrating the effect of a color match sigma parameter. All three images show a logo or label with the text “Snow King Mountain.”

Image 705 is the baseline image, representing the output of the core super-resolution model without the specific Text-SR enhancement related to color matching. The text “Snow King Mountain” is present. While readable, it might have some slight color shifts or blending imperfections around the edges compared to the ideal. The overall colors might appear a bit desaturated or subtly off from the intended appearance. This image 705 serves as the control for evaluating the color match sigma parameter.

Image 710 shows the result when the Text-SR module is applied with a color match sigma of 2.0. This parameter influences how the Text-SR module attempts to match the color characteristics of the input text. A higher sigma might imply more aggressive smoothing or blending of colors. Compared to the model image 705, the text's colors and integration into the background appear improved, with reduced artifacts or more consistent color tones around the text. The sharpness is enhanced due to the Text-SR module's general function.

Image 715 displays the outcome when the Text-SR module is used with a reduced color match sigma of 0.5. A lower sigma often indicates a more subtle or less aggressive application of a filter or blending. Reducing colormatch_sigma_blur helps with spatial variation. A lower sigma for color matching would lead to a more accurate and spatially precise color reproduction around the text. Visually, image 715 presents the best color accuracy and least color-related artifacts around the text compared to the other two, potentially resulting in the most natural-looking text integration.

FIG. 7A illustrates how the color match sigma parameter in the Text-SR module impacts the color fidelity and integration of super-resolved text. A lower sigma value appears to lead to better spatial variation and color matching, resulting in more natural and artifact-free text rendering.

FIG. 7B is another image illustrating text processing, in accordance with example embodiments. FIG. 7B displays three images, arranged horizontally, demonstrating the impact of the Super-Resolution (SR) model on image quality, specifically focusing on a texture enhancement or detail preservation aspect, as evidenced by the “alcohol pad” image. All three images are close-ups of an alcohol pad, highlighting its texture and details.

Image 720 is the input image. Image 725 serves as the baseline, representing the output of the model (e.g., the core super-resolution model without specific texture enhancement). The texture of the alcohol pad appears smooth or less defined. The fine details and fibers of the pad might not be as prominent or sharp. Image 720 provides a point of comparison to evaluate the effectiveness of the enhancement shown in the other images. Compared to the input image 720, there is a noticeable improvement in the texture and details of the alcohol pad. The fibers and surface irregularities appear more defined and sharper.

Image 730 displays the outcome when the Text-SR module is used with the base model. Comparing this to the middle image 725, there appears to be a further enhancement in sharpness and fine detail. The texture of the alcohol pad is even more crisp, and subtle details are more visible.

### Temporal Consistency

Gradient blending is a technique to control texture hallucinations when applying generative models (e.g., LANCET-Alpha, Kepler_GAN, gLDM-SR) on Video-Boost test frames. The output from these models are of high quality when generating details in high-frequency regions but may look unrealistic when injecting unnecessary details in low-frequency regions of the input image. By thresholding and normalizing image gradients between two manual thresholds, a spatially-varying alpha map may be generated that only blends in SR model output in image-regions with large gradients.

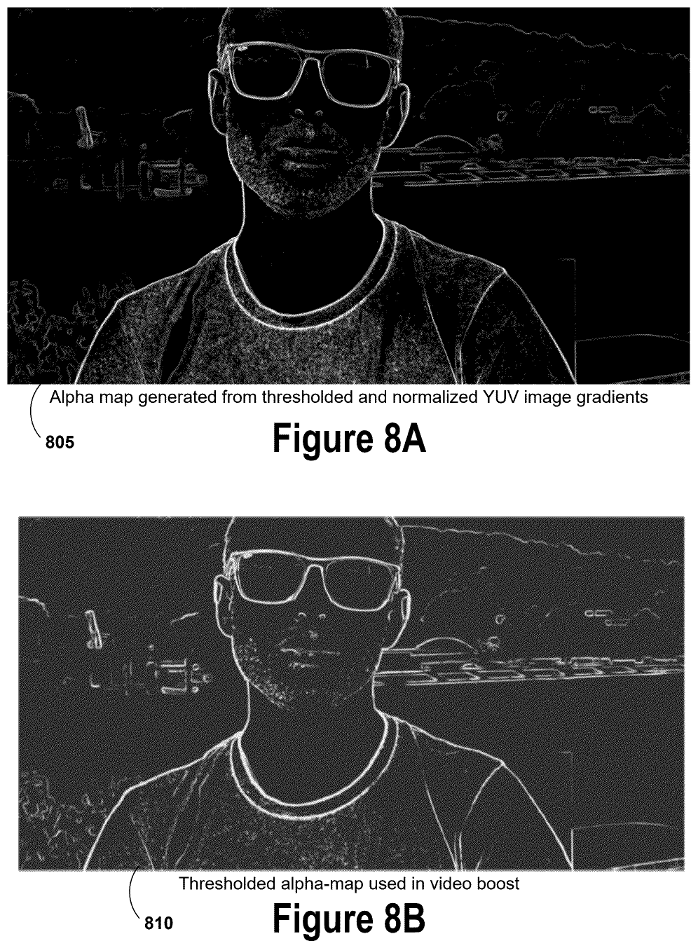

FIG. 8A is an image of an alpha map, in accordance with example embodiments. An alpha map is typically used in image processing and computer graphics to control the transparency or blending of one image with another. In this context, the alpha map is derived from the image gradients of a YUV image. FIG. 8A visually represents an alpha map generated from the thresholded and normalized gradients of a YUV image. This map is a significant component in gradient-blending, used to control the spatial variation of blending based on image features like edges.

The process starts with a YUV image. YUV is a color encoding system that separates the luma, or brightness component (Y) from the chroma, or color components (U and V). Image gradients measure the change in intensity or color across an image. Calculating gradients in the YUV color space means considering the changes in brightness and color separately.

The image gradients are then thresholded and normalized. Thresholding involves setting a cutoff value. Gradient values above this cutoff value might be treated differently than those below. This is often used to highlight areas with significant changes (e.g., edges) while suppressing areas with minor changes. Normalization typically involves scaling the values to a specific range, often between 0 and 1. This ensures that the alpha map values are within a usable range for controlling blending.

The processed (thresholded and normalized) YUV image gradients are used to create the alpha map. The appearance of the alpha map in FIG. 8A shows variations in grayscale or color intensity, where different intensity levels correspond to different alpha (transparency/blending) values. FIG. 8A shows an image 805 where areas with strong image gradients (e.g., edges of objects) are represented with higher alpha values (less transparency, more blending), while areas with weak gradients (e.g., smooth regions) have lower alpha values (more transparency, less blending). The image 805 appears as a grayscale representation where brighter areas indicate higher alpha values and darker areas indicate lower alpha values.

In the context of super-resolution, an alpha map created from image gradients can be used in gradient-blending to control how the super-resolved output is blended with the original input image. Areas with strong gradients (e.g., edges) might be blended towards the super-resolved output to enhance sharpness, while smooth areas might be blended towards the original input to avoid amplifying noise or artifacts.

FIG. 8B is another image of an alpha map, in accordance with example embodiments. FIG. 8B displays an image 810 that represents a thresholded alpha-map. Building upon the concept of an alpha map discussed with reference to FIG. 8A, a thresholded alpha-map can be generated by applying a threshold to the original alpha-map. This process simplifies the alpha-map, often resulting in areas that are either fully opaque (alpha=1) or fully transparent (alpha=0), or perhaps a few discrete levels in between, rather than a continuous range of alpha values.

The image 810 in FIG. 8B is the result of applying a thresholding operation to an alpha-map (one similar to what was shown in FIG. 8A, derived from image gradients). This thresholding step converts the continuous or near-continuous alpha values into a more simplified set of values. For example, all alpha values below a certain threshold might be set to 0 (fully transparent), and all values above the threshold might be set to 1 (fully opaque). This thresholded alpha-map is used in Video-boost. Video-boost is a feature or process within the video super-resolution system aimed at enhancing video quality. The thresholded alpha-map can be used within the Video-boost process to guide how various parts of the video frames are processed or blended.

FIG. 8B shows an image 810 with distinct regions of different alpha values. Instead of a smooth grayscale transition seen in a non-thresholded alpha-map, image 810 displays sharper boundaries between areas with high alpha (e.g., areas to be enhanced or kept more opaque) and areas with low alpha (e.g., areas to be made more transparent or less enhanced). The appearance could be binary (black and white) if a single threshold is applied or have a few distinct grayscale levels if multiple thresholds are used. Areas with strong gradients in the original image (e.g., edges) are likely to correspond to regions with higher alpha values in this thresholded map, as the thresholding would emphasize these areas. Image 810 in FIG. 8B visually represents a thresholded alpha-map, which is a simplified version of an alpha-map derived from image gradients. This map is used within a Video-boost process to guide spatially varying enhancement or blending, allowing for a more targeted approach to improving video quality by emphasizing certain areas based on their gradient information.

In the context of Video-boost, using a thresholded alpha-map allows for a more decisive application of enhancement or blending. For instance, areas identified by high alpha values in the thresholded map might receive more aggressive super-resolution processing or be blended more strongly with the super-resolved output, while areas with low alpha might be processed differently or blended more with the original low-resolution frame. This targeted approach can help in enhancing specific features (e.g., edges or textures) while potentially minimizing the amplification of noise in smoother regions.

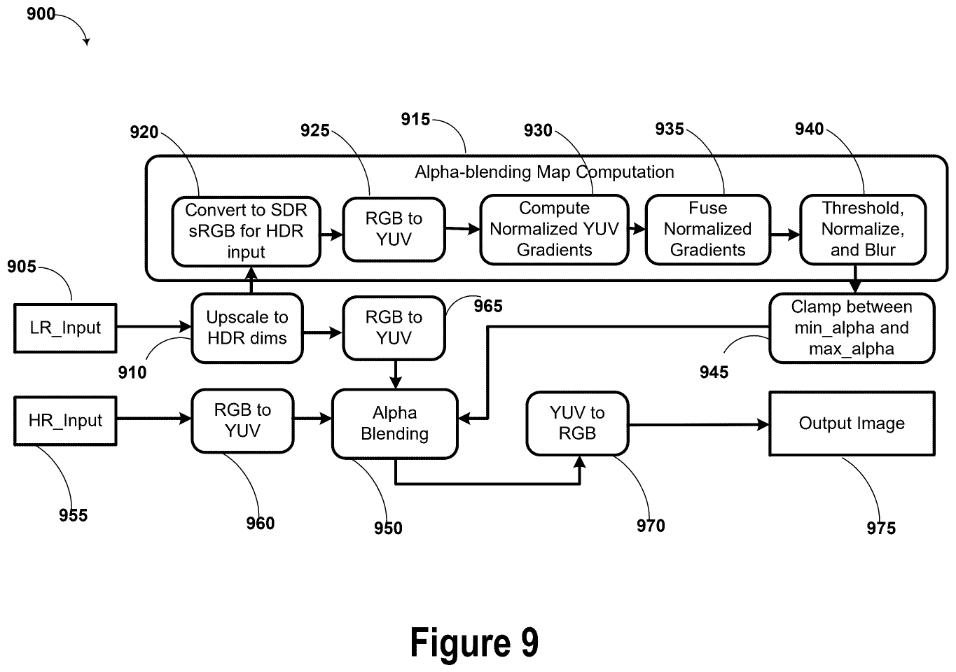

FIG. 9 is a block diagram 900 illustrating gradient blending, in accordance with example embodiments. FIG. 9 details the process of creating an alpha blending map, which is used to control the blending of different image sources based on image features.

Input Image (LR) 905 is the low-resolution input image. It serves as the base from which image gradients are calculated. The Input Image (LR) 905 is upscaled to HDR dimensions at upscale block 910. The upscaled output is provided to the alpha-blending map computation block 915.

One design choice is to calculate image gradients on the upscaled LR image (instead of calculating gradient map on LR image and then upscaling). For higher digital-zoom ratios, the corresponding image gradient strength will be lower. That is because the same intensity-delta may be spread across more pixels after upscaling. Hence, less of the SR model output may be blended at higher scale-factors (capped by min_alpha).

To address inconsistency between SDR and HDR image gradients, the input image (LR) 905 may be converted to SDR sRGB for HDR input at block 920 via an approximate conversion before gradient computation. The output undergoes YUV conversion at RGB to YUV block 925. As described, YUV is a color space that separates luma (brightness) from chroma (color). Converting to YUV allows for the calculation of gradients on the brightness component (Y), which is often more relevant for identifying edges and textures. After YUV conversion, image gradients may be determined for the Y (luma) channel. These gradients measure the change in brightness across the image, highlighting areas with significant variations like edges.

Normalized YUV gradients may be determined at block 930 and the normalized gradients may be fused at block 935. The calculated Image Gradients (Y) are then subjected to Thresholding. This process sets a cutoff value, effectively creating a mask that emphasizes areas with strong gradients while suppressing areas with weak gradients. This helps to isolate important image features like edges.

Threshold, normalize and blur operations may be applied at block 940. For example, following thresholding, the data may be normalized. This scales the thresholded gradient values to a specific range, typically between 0 and 1. This normalized output is the raw alpha map data. The normalized data then passes through a Gaussian blur filter. Applying a Gaussian blur smooths the alpha map, reducing sharp transitions and creating a more gradual blending effect. The degree of blur can be controlled by a sigma parameter.

The output of the Gaussian blur is the final Alpha Blending Map. This map contains values between 0 and 1 (due to normalization and smoothing), where each value at a specific pixel location indicates the desired blending ratio between two image sources. Higher values in the alpha map would typically correspond to areas where one source should be more prominent, while lower values would favor the other source. The final output of this process is the generated Alpha Blending Map, ready to be used in an alpha blending operation.

The upscaled output from upscale block 910 undergoes YUV conversion at RGB to YUV block 965. This is provided to the alpha blending block 950. Also, HR_input 955 undergoes YUV conversion at RGB to YUV block 960. This is also provided to the alpha blending block 950. Final alpha-blending may be applied in the HDR-domain.

In some embodiments, an additional thresholding or clamping operation 945 may be applied to the alpha map. For example, for on-device image upscaling using LANCET-Alpha, the input may be blended with the super-res model output with a fixed alpha of 0.3. Inspired by this, the alpha-map may be clamped between min_alpha and max_alpha (e.g., [0.2, 0.9]). For example, instead of allowing the alpha values to range freely from 0 to 1 (or whatever range the initial normalization produced), they are now forced to fall within a specific, narrower range, in this case, between 0.2 and 0.9. Any alpha value originally less than 0.2 is set to 0.2. Any alpha value originally greater than 0.9 is set to 0.9. Alpha values already between 0.2 and 0.9 remain unchanged.

A lower min_alpha may be used compared to the LANCET-Alpha model to reduce texture flicker from SR model outputs. The lower min_alpha here (0.2 vs. 0.3 for LANCET-Alpha) results in a fine-tuning to balance the SR model's contribution with temporal stability. A smaller minimum contribution from the SR model in smooth areas can help reduce perceived flickering that might arise from subtle, inconsistent noise or “hallucinations” generated by the SR model in these regions across frames.

The upper clamp of 0.9 implies that even in the strongest edge regions, there might still be a small (10%) contribution from the alternative source (like RAISR, as discussed in the context of gradient blending), to maintain some baseline stability or avoid over-sharpening artifacts.

In some embodiments, the clamped alpha map may be prepared for and integrated into a video-boost pipeline. The video-boost is an overall system or feature aimed at enhancing video quality and involves super-resolution techniques. In this context, the thresholded alpha map acts as a dynamic blending mask. When blending the SR model's output with another source (e.g., RAISR or the original input), the alpha map's value at each pixel determines the ratio. For example, if the alpha value is 0.9, 90% of the final pixel value comes from the SR output and 10% from the alternative source. If the alpha value is 0.2, 20% comes from the SR output and 80% from the alternative.

This ensures that there is always some contribution to the output image from the SR model. By setting a minimum alpha of 0.2, even in the smoothest areas (where gradients are low), the Super Resolution (SR) model's output will still contribute at least 20% to the final blended image. This prevents completely discarding the SR output, which might still contain valuable subtle details or maintain a consistent “look.”

HR_Input 955 represents the High-Resolution Input image. In the context of super-resolution, this could be the original high-resolution image (if available) or the output of another high-resolution process that is being blended with the super-resolved output or the LR input.

The alpha blending map was determined previously (derived from the LR input's gradients, thresholding, normalization, and Gaussian blur). This map, with values typically between 0 and 1, dictates the blending ratio at each pixel.

The Alpha Blending Block 950 visually represents the Alpha Blending operation itself. It takes the YUV version of HR_Input 955, the Alpha Blending Map, and another image source (such as the YUV version of LR Input 905 or the super-resolved output) as inputs. The Alpha Blending Block 950 combines the two (or more) image sources based on the pixel-by-pixel values in the Alpha Blending Map.

The output of this Alpha Blending block 950 undergoes YUV to RGB conversion at block 970 and is the resulting blended output image 975. This output image 975 has characteristics of both input sources, combined according to the spatial variations defined by the Alpha Blending Map.

FIG. 9 provides a detailed breakdown of how an alpha blending map is computed from a low-resolution input image. The process involves converting to YUV, calculating and processing image gradients (e.g., thresholding and normalization), and then applying a Gaussian blur to create a smooth map that can control spatially varying blending based on the image's brightness features. This alpha blending map is used to combine super-resolved output with the original input image in a way that enhances edges and textures while maintaining smooth regions. Additionally, FIG. 9 shows the practical application of the alpha blending map. It demonstrates how the HR_Input 955 may be blended with another image source (implicitly) using the generated alpha map to achieve a spatially varying combination. This is a significant step in gradient blending, where the alpha map guides the merging of different image versions to enhance specific features while maintaining overall image quality.

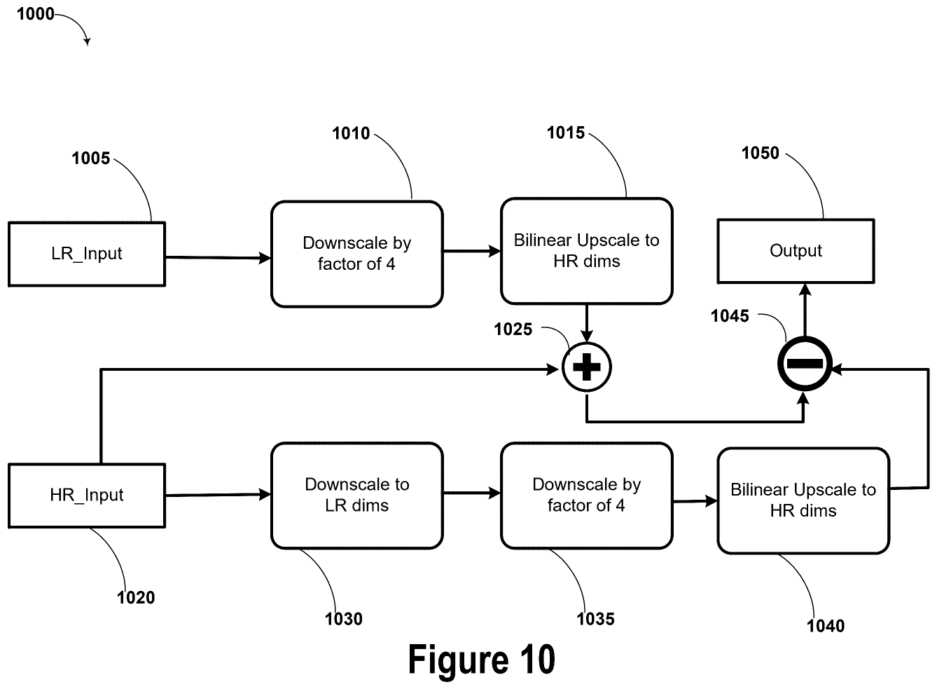

FIG. 10 is a block diagram 1000 illustrating an example low frequency (LF) replace, in accordance with example embodiments. FIG. 10 illustrates a process related to Low-Frequency (LF) signal extraction and replacement, for maintaining brightness and color consistency. This figure shows how low-frequency components may be derived from both the Low-Resolution (LR) and High-Resolution (HR) inputs, and how they might be used. LF-replace may be used to resolve the issue where the model output may deviate slightly from the input in terms of brightness and/or color regardless of the upscaler model being used. LF-replace is a low-frequency add-on for the Kepler_GAN model. A standard image processing ops may be used to replace the low-frequency signal in the final blended output.

LR_Input 1005 is the Low-Resolution input image. It is the original, lower-resolution image from which a low-frequency signal is extracted. The LR_Input 1005 undergoes a downscale by factor of 4 operation at block 1010. This heavily downscales the LR image 1005, effectively removing high-frequency details and isolating the very low-frequency information (e.g., overall brightness and coarse color).

The output of the downscale by factor of 4 operation at block 1010 is then subjected to a bilinear upscale to High Resolution dimensions (HR dims) at block 1015. This upscales the heavily downscaled LR image back to the dimensions of the HR image, using bilinear interpolation for smoothing. The result is a low-frequency version of the LR input 1005, but at HR dimensions. This path creates an LR-derived low-frequency component that is scaled to match the HR dimensions.

HR_Input 1020 is a High-Resolution input image. In the context of super-resolution, this may be the super-resolved output from the main model, or the ground truth HR image used for comparison.

A single downscale call at block 1030 may be used to obtain the low-frequency signal for HR_input 1020. This may result in halo artifacts for certain fractional scaling factors. For such scaling factors, the low-frequency downsampled images may be slightly misaligned between LR_input 1005 and HR_input 1020. To resolve the misalignment, a double-downscale may be used, as described below.

The HR_Input 1020 undergoes a downscale to LR dims operation at block 1030. This brings the HR image down to the dimensions of the original LR input 1005. The output of the downscale to LR dims operation at block 1030 is then subjected to a downscale by factor of 4 operation at block 1035. This second downscaling step (from the effectively LR-sized image) isolates the very low-frequency component. To resolve any misalignment, a double-downscale may be used. This double-downscale ensures correct alignment of low-frequency signals.

The result of the second downscale is then upscaled back to HR dims using bilinear interpolation at block 1040. This path creates an HR-derived low-frequency component that is at HR dimensions and is aligned with the low-frequency component from the LR path.

The output of the bilinear upscale to HR dims from the top path (LR-derived LF at HR dims) at block 1015 and the HR_Input 1020 are then fed into an addition (+) block 1025.

The outputs of the addition block 1025, and the bilinear upscale to HR dims from the bottom path (HR-derived LF at HR dims) at block 1040 flow into the subtraction (−) block 1045. This block computes the difference between these two low-frequency signals. This difference, or delta, represents the color and brightness shifts between the original LR input's low-frequency characteristics and the super-resolved output's low-frequency characteristics.

The final output 1050 of this subtraction block 1045 is the corrected super-resolved image, with its color and brightness shifts adjusted based on the low-frequency difference between the LR input 1005 and the HR output.

FIG. 10 is a diagram of the Low-Frequency Replace block. It shows how low-frequency components are extracted and scaled from both the LR input and the HR output, their difference is computed (the delta), and this delta is then added back to the main HR output (super-resolved image) to correct color and brightness discrepancies.

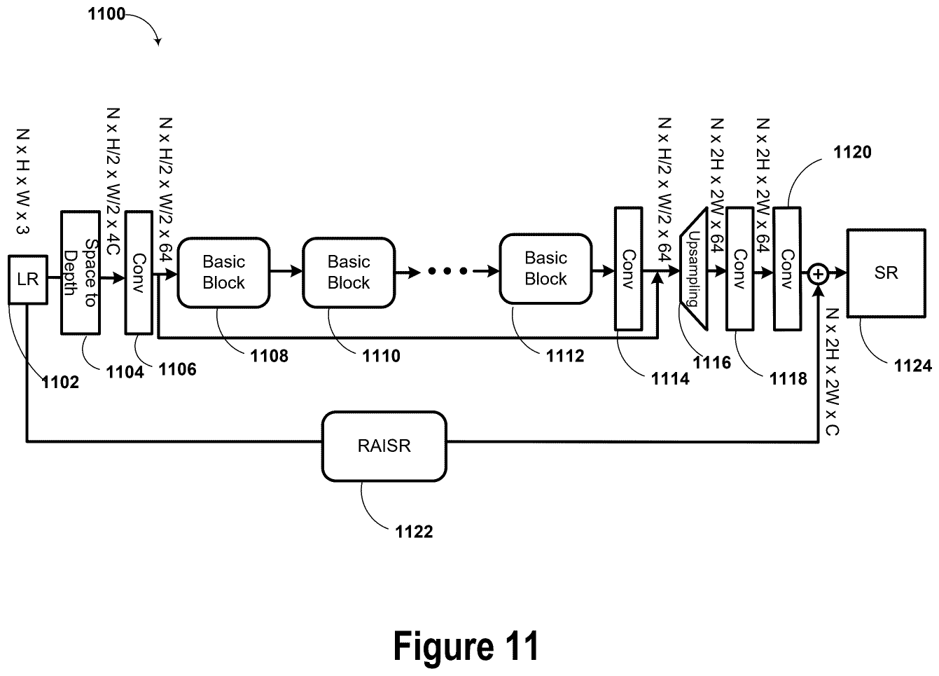

FIG. 11 is a diagram illustrating an example model architecture 1100 for Rapid and Accurate Image Super-Resolution (RAISR), in accordance with example embodiments. FIG. 11 describes a Super Resolution (SR) architecture, which is a system designed to take a low-resolution image and create a higher-resolution version of it. As previously described, it involves components like Space to Depth, Convolutional Layers, Basic Blocks, RAISR, and Upsampling to achieve this upscaling. The focus is on the process of enhancing image resolution.

LR (Low Resolution) Input 1102 is the initial input to the system, represented as N×H×W×3, indicating a batch of N images with Height (H) , Width (W), and 3 color channels (e.g., RGB).

The Space to Depth component 1104 takes the LR input 1102 and transforms it. It downscales the input by a factor of 2, resulting in dimensions of N×H/2×W2×4 C, where C represents the number of color channels.

A convolutional layer 1106 processes the output of the Space to Depth component 1104, changing its dimensions to N×H/2×W/2×64.

There may be multiple Basic Block components 1108, 1110, 1112, arranged in series. These blocks perform further processing and feature extraction. The output of Basic Block 1112 may be provided to convolutional layer 1114.

The Upsampling component 1116 increases the resolution of the image, transforming N×H/2×W/2×64 to N×2H×2W×64.

Convolutional layers 1118, 1120 process the upsampled output, maintaining the N×2H×2W×64 dimensions.

The outputs of the convolutional layer 1120 and the RAISR component 1122 are added by adder circuitry to output the SR image 1124 with dimensions N×2H×2W×C. RAISR is a filter-based algorithm that helps maintain temporal stability.

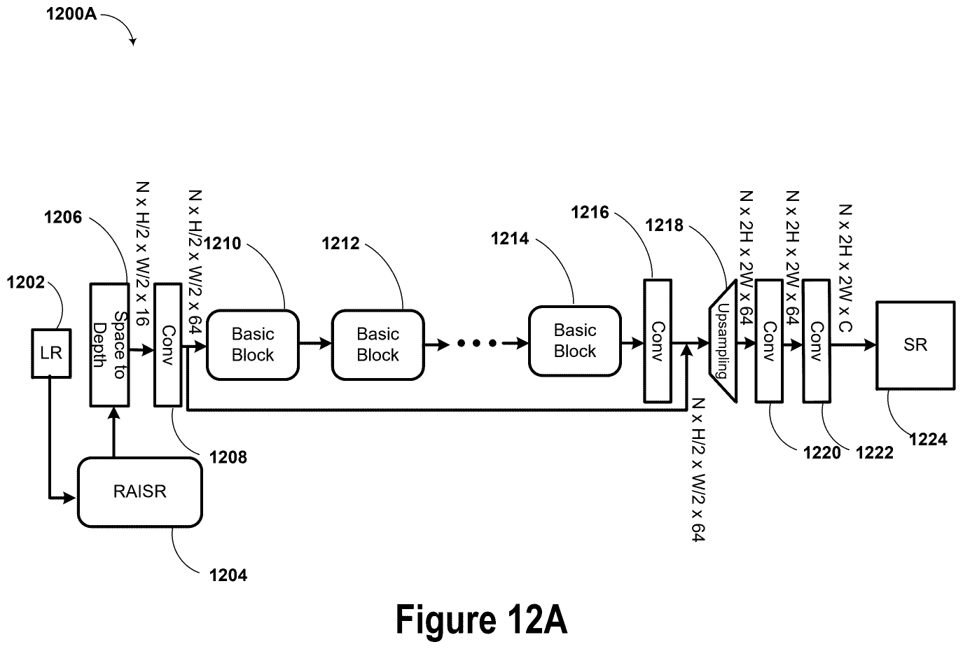

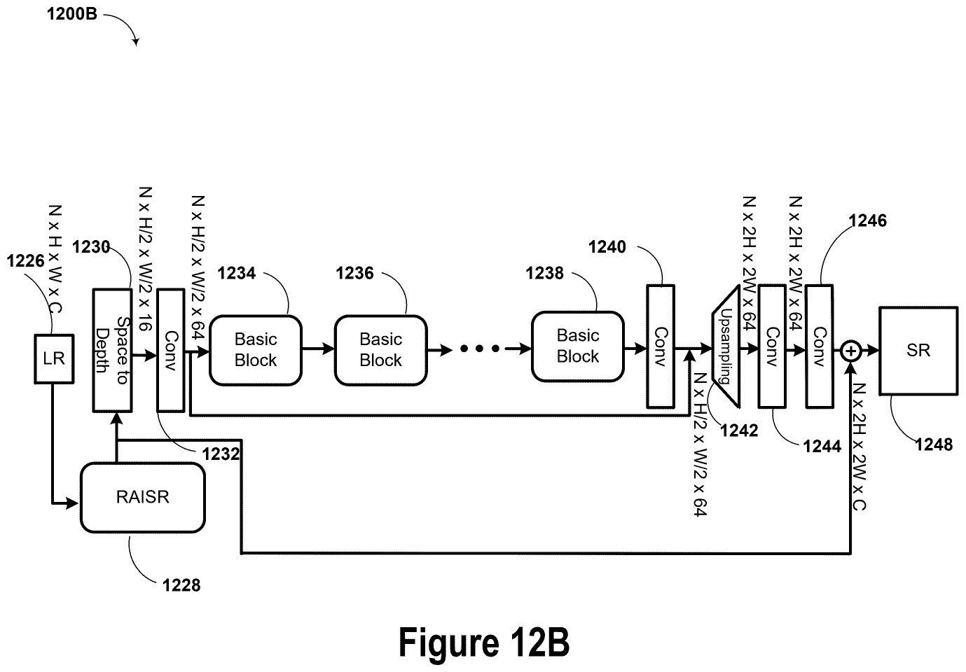

FIGS. 12A and 12B illustrate example model architectures for RAISR, in accordance with example embodiments. This alpha map is used for blending, and FIG. 12B illustrates use in a video-boost application after further thresholding. The focus here is on using image gradients to create a blending map, rather than directly increasing image resolution.

FIG. 12A is a diagram illustrating an example model architecture 1200A, in accordance with example embodiments.

LR (Low Resolution) Input 1202 is the initial input to the system, represented as N×H×W×3, indicating a batch of N images with Height (H) , Width (W), and 3 color channels (e.g., RGB). LR Input 1202 is provided to RAISR component 1204. RAISR is a filter-based algorithm that helps maintain temporal stability.

The Space to Depth component 1206 takes the output of the RAISR component 1204 and transforms it. It downscales the input by a factor of 2, resulting in dimensions of N×H/2×W/2×16.

A convolutional layer 1208 processes the output of the Space to Depth component 1206, changing its dimensions to N×H/2×W/2×64.

There may be multiple Basic Block components 1210, 1212, 1214, arranged in series. These blocks perform further processing and feature extraction. The output of Basic Block 1214 may be provided to convolutional layer 1216.

The Upsampling component 1218 increases the resolution of the image, transforming N×H/2×W/2×64 to N×2H×2W×64.

Convolutional layers 1220, 1222 process the upsampled output, maintaining the N×2H×2W×64 dimensions.

The convolutional layer 1222 outputs the SR image 1224 with dimensions N×2H×2W×C, where C represents the number of color channels.

FIG. 12B is another diagram illustrating an example model architecture 1200B, in accordance with example embodiments. In some aspects, the architecture in FIG. 12B is a combination of the architectures described with reference to FIGS. 11 and 12A.

LR (Low Resolution) Input 1226 is the initial input to the system, represented as N×H×W×C, indicating a batch of N images with Height (H) , Width (W), and where C represents the number of color channels. LR Input 1226 is provided to RAISR component 1228. RAISR is a filter-based algorithm that helps maintain temporal stability.

The Space to Depth component 1230 takes the output of the RAISR component 1228 and transforms it. It downscales the input by a factor of 2, resulting in dimensions of N×H/2×W/2×16.

A convolutional layer 1232 processes the output of the Space to Depth component 11330, changing its dimensions to N×H/2×W/2×64.

There may be multiple Basic Block components 1234, 1236, 1238, arranged in series. These blocks perform further processing and feature extraction. The output of Basic Block 1238 may be provided to convolutional layer 1240.

The Upsampling component 1242 increases the resolution of the image, transforming N×H/2×W/2×64 to N×2H×2W×64.

Convolutional layers 1244, 1246 process the upsampled output, maintaining the N×2H×2W×64 dimensions.

The output of the convolutional layer 1246 and the RAISR component 1228 are added by adder circuitry to output the SR image 1248 with dimensions N×2H×2W×C.

### Ablations

Several ablation studies may be performed for inference model training. For example, ablation studies may be performed based on a number of iterations for GAN model training. As another example, discriminator weights may be reset after a certain number of iterations. Also, for example, discriminator weight updates may be stopped after a certain number of iterations. As another example, a two stage GAN training may be used. For example, the GAN model may be trained for a certain number of iterations, then the previous GAN weights may be re-trained for a certain number of iterations. This can be similar to resetting discriminator weights, but with generator and discriminator optimizer states being completely reset.

Hyperparameter ablations for model training may be performed based on batch size, learning-rate decay vs. fixed learning-rate, and by adding a focal frequency-loss to GAN training.

When applying super-resolution solutions directly to video, several challenges may be encountered, such as, for example, temporal coherence issues, artifacts and/or hallucinations, brightness/color accuracy issues, and image quality (IQ) vs. tiling issues. IQ vs. tiling refers to the trade-off between image quality (IQ) and the computational strategy of tiling in super-resolution models, especially in the context of video. For example, temporal coherence issues can involve visible flickers that can be observed at high-frequency areas. As described herein, these challenges may be addressed by analyzing input gradients and blending inference results with RAISR input. Regions with high-frequency edges lean towards the inference result, while regions with low gradient blend towards RAISR, making edges with intermediate gradient less sharp and temporally stable.

The super-resolution model has to guess and generate details that are not present in the low-resolution input, which can lead to artifacts or hallucination. These challenges may be addressed by adding different blurriness/noise during training data augmentation to balance hallucination and output sharpness. For sensitive areas like faces and text, dedicated strategies like replacing with RAISR results for faces or dedicated text SR models for texts may be used.

Generative models can shift the brightness and color from input frames. A low-frequency (LF)-replace block may be configured to compute the RGB difference between input and output in a downsampled domain, upscale it, and add the delta to the output to align the final output with the input brightness and color.

Tiling is a technique used to break down a large image or video frame into smaller, manageable “tiles” or sub-images. These smaller tiles can then be processed independently and in parallel by the super-resolution model. Accordingly, tiling enables parallel computation to shorten inference latency, but the variable input size of the super-resolution model, dependent on the zoom ratio, can make proper tiling strategy and intersection management challenging.

The primary advantage of tiling is that it significantly shortens inference latency. By processing smaller portions of the image at a time, the computational load is distributed, and memory requirements for individual processing units are reduced. This is particularly crucial for real-time video processing.

Unlike other models with fixed input sizes, super-resolution models often have variable input sizes. This variability is dependent on the “zoom ratio” or the desired upscaling factor. For example, upscaling a 4K image to 8K requires a different input size consideration than upscaling from 1080p to 4K. This dynamic input size makes it challenging to implement a consistent and efficient tiling strategy.

When an image is divided into tiles, there are overlapping regions at the boundaries of these tiles. When each tile is processed independently, artifacts or inconsistencies can arise at these intersection points. Proper handling of these overlaps ensures a seamless and artifact-free reconstructed image. This might involve blending techniques or careful selection of the tile boundaries.

The overarching goal of super-resolution is to enhance the image quality of low-resolution input, generating a sharper, more detailed, and visually pleasing high-resolution output. While tiling improves efficiency, it can negatively impact IQ if not implemented carefully. As mentioned, poor handling of tile intersections can introduce visible seams, ringing, or other artifacts, degrading the overall image quality. Processing images in small tiles might limit the model's ability to leverage global context or information that spans across tile boundaries. This could potentially lead to less coherent or realistic details, especially in complex textures or large-scale patterns.

To mitigate boundary artifacts, blending techniques may be employed. These techniques can add computational overhead and, if not optimized, could diminish the performance gains from tiling. As described herein, algorithms may be developed that can dynamically adjust tiling parameters based on the zoom ratio and input image characteristics. Robust blending methods may be implemented to seamlessly merge the processed tiles, minimizing visible artifacts at intersections. This could involve weighted blending, feathering, or more intelligent approaches that consider image content at the boundaries. Also, for example, the super-resolution model itself may be designed to be more robust to tiling, by incorporating mechanisms that reduce reliance on strict local context or by having receptive fields that can effectively span across tile boundaries.

### Training Machine Learning Models for Generating Inferences/predictions

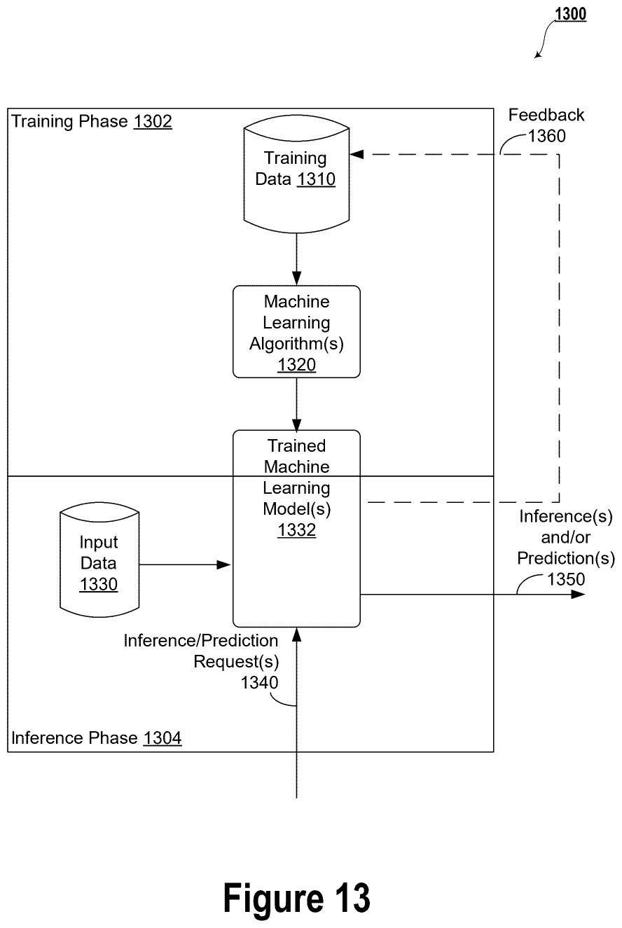

FIG. 13 shows diagram 1300 illustrating a training phase 1302 and an inference phase 1304 of trained machine learning model(s) 1332, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 13 shows training phase 1302 where machine learning algorithm(s) 1320 are being trained on training data 1310 to become trained machine learning model(s) 1332. Then, during inference phase 1304, trained machine learning model(s) 1332 can receive input data 1330 and one or more inference/prediction requests 1340 (as part of input data 1330) and responsively provide as an output one or more inferences and/or prediction(s) 1350.

As such, trained machine learning model(s) 1332 can include one or more models of machine learning algorithm(s) 1320. Machine learning algorithm(s) 1320 may include but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 1320 may be supervised or unsupervised and may implement any suitable combination of online and offline learning.

In some examples, machine learning algorithm(s) 1320 and/or trained machine learning model(s) 1332 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 1320 and/or trained machine learning model(s) 1332. In some examples, trained machine learning model(s) 1332 can be trained, reside and execute to provide inferences on a particular computing device, and/or otherwise can make inferences for the particular computing device.

During training phase 1302, machine learning algorithm(s) 1320 can be trained by providing at least training data 1310 as training input using unsupervised, supervised, semi-supervised, and/or reinforcement learning techniques. Unsupervised learning involves providing a portion (or all) of training data 1310 to machine learning algorithm(s) 1320 and machine learning algorithm(s) 1320 determining one or more output inferences based on the provided portion (or all) of training data 1310. Supervised learning involves providing a portion of training data 1310 to machine learning algorithm(s) 1320, with machine learning algorithm(s) 1320 determining one or more output inferences based on the provided portion of training data 1310, and the output inference(s) are either accepted or corrected based on correct results associated with training data 1310. In some examples, supervised learning of machine learning algorithm(s) 1320 can be governed by a set of rules and/or a set of labels for the training input, and the set of rules and/or set of labels may be used to correct inferences of machine learning algorithm(s) 1320.

Semi-supervised learning involves having correct results for part, but not all, of training data 1310. During semi-supervised learning, supervised learning is used for a portion of training data 1310 having correct results, and unsupervised learning is used for a portion of training data 1310 not having correct results. Reinforcement learning involves machine learning algorithm(s) 1320 receiving a reward signal regarding a prior inference, where the reward signal can be a numerical value. During reinforcement learning, machine learning algorithm(s) 1320 can output an inference and receive a reward signal in response, where machine learning algorithm(s) 1320 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 1320 and/or trained machine learning model(s) 1332 can be trained using other machine learning techniques, including but not limited to, incremental learning and curriculum learning.

In some examples, machine learning algorithm(s) 1320 and/or trained machine learning model(s) 1332 can use transfer learning techniques. For example, transfer learning techniques can involve trained machine learning model(s) 1332 being pre-trained on one set of data and additionally trained using training data 1310. More particularly, machine learning algorithm(s) 1320 can be pre-trained on data from one or more computing devices and a resulting trained machine learning model provided to a particular computing device, where the particular computing device is intended to execute the trained machine learning model during inference phase 1304. Then, during training phase 1302, the pre-trained machine learning model can be additionally trained using training data 1310, where training data 1310 can be derived from kernel and non-kernel data of the particular computing device. This further training of the machine learning algorithm(s) 1320 and/or the pre-trained machine learning model using training data 1310 of the particular computing device's data can be performed using either supervised or unsupervised learning. Once machine learning algorithm(s) 1320 and/or the pre-trained machine learning model has been trained on at least training data 1310, training phase 1302 can be completed. The trained resulting machine learning model can be utilized as at least one of trained machine learning model(s) 1332.

In particular, once training phase 1302 has been completed, trained machine learning model(s) 1332 can be provided to a computing device, if not already on the computing device. Inference phase 1304 can begin after trained machine learning model(s) 1332 are provided to the particular computing device.

During inference phase 1304, trained machine learning model(s) 1332 can receive input data 1330 and generate and output one or more corresponding inferences and/or prediction(s) 1350 about input data 1330. As such, input data 1330 can be used as an input to trained machine learning model(s) 1332 for providing corresponding inference(s) and/or prediction(s) 1350 to kernel components and non-kernel components. For example, trained machine learning model(s) 1332 can generate inference(s) and/or prediction(s) 1350 in response to one or more inference/prediction requests 1940. In some examples, trained machine learning model(s) 1332 can be executed by a portion of other software. For example, trained machine learning model(s) 1332 can be executed by an inference or prediction daemon to be readily available to provide inferences and/or predictions upon request. Input data 1330 can include data from the particular computing device executing trained machine learning model(s) 1332 and/or input data from one or more computing devices other than the particular computing device.

Input data 1330 can include a plurality of video frames captured at a first resolution. Other types of input data are possible as well. Inference(s) and/or prediction(s) 1350 can include an upscaled version of the plurality of video frames to a second resolution, wherein the second resolution is higher than the first resolution. Inference(s) and/or prediction(s) 1350 can include other output data produced by trained machine learning model(s) 1332 operating on input data 1330 (and training data 1310). In some examples, trained machine learning model(s) 1332 can use output inference(s) and/or prediction(s) 1350 as input feedback 1960. Trained machine learning model(s) 1332 can also rely on past inferences as inputs for generating new inferences.

Convolutional neural networks and/or deep neural networks used herein can be an example of machine learning algorithm(s) 1320. For example, machine learning algorithm(s) 1320 may include generative adversarial networks (GANs) described herein. After training, the trained version of a convolutional neural network can be an example of trained machine learning model(s) 1332. In this approach, an example of the one or more inference/prediction requests 1340 can be a request to predict an upscaled version of the plurality of video frames to a second resolution, wherein the second resolution is higher than a first resolution for input video frames, and a corresponding example of inferences and/or prediction(s) 1350 can be the upscaled version of the plurality of video frames to a second resolution.

### Example Data Network

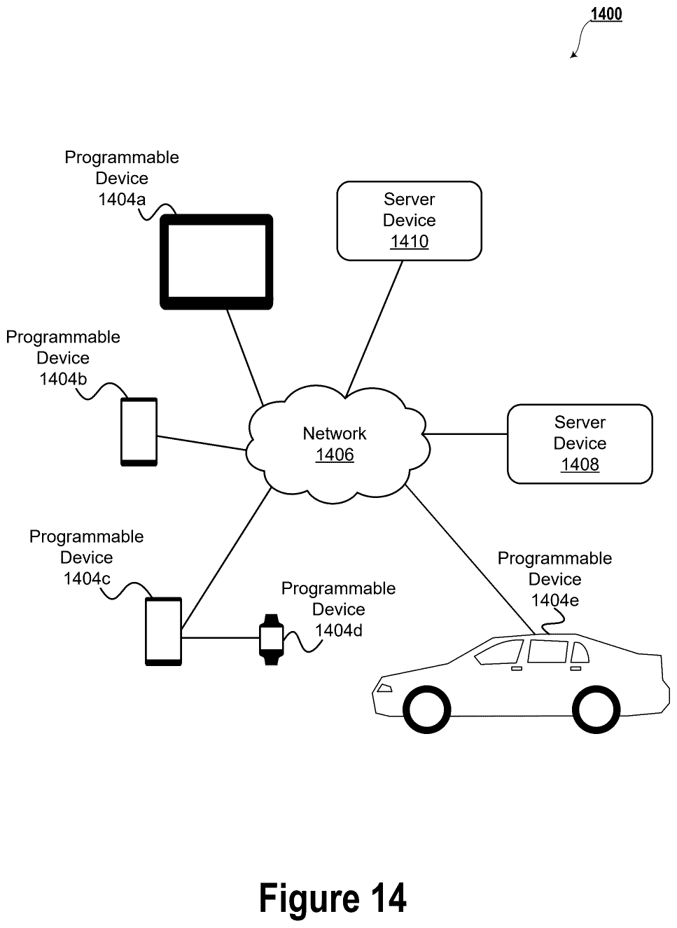

FIG. 14 depicts a distributed computing architecture 1400, in accordance with example embodiments. Distributed computing architecture 1400 includes server devices 1408, 1410 that are configured to communicate, via network 1406, with programmable devices 1404a, 1404b, 1404c, 1404d, 1404e. Network 1406 may correspond to a local area network (LAN), a wide area network (WAN), a WLAN, a WWAN, a corporate intranet, the public Internet, or any other type of network configured to provide a communications path between networked computing devices. Network 1406 may also correspond to a combination of one or more LANs, WANs, corporate intranets, and/or the public Internet.

Although FIG. 14 only shows five programmable devices, distributed application architectures may serve tens, hundreds, or thousands of programmable devices. Moreover, programmable devices 1404a, 1404b, 1404c, 1404d, 1404e (or any additional programmable devices) may be any sort of computing device, such as a mobile computing device, desktop computer, wearable computing device, head-mountable device (HMD), network terminal, a mobile computing device, and so on. In some examples, such as illustrated by programmable devices 1404a, 1404b, 1404c, 1404e, programmable devices can be directly connected to network 1406. In other examples, such as illustrated by programmable device 1404d, programmable devices can be indirectly connected to network 1406 via an associated computing device, such as programmable device 1404c. In this example, programmable device 1404c can function as an associated computing device to pass electronic communications between programmable device 1404d and network 1406. In other examples, such as illustrated by programmable device 1404e, a computing device can be part of and/or inside a vehicle, such as a car, a truck, a bus, a boat or ship, an airplane, etc. In other examples not shown in FIG. 3, a programmable device can be both directly and indirectly connected to network 1406.

Server devices 1408, 1410 can be configured to perform one or more services, as requested by programmable devices 1404a-1404e. For example, server device 1408 and/or 1410 can provide content to programmable devices 1404a-1404e. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server devices 1408 and/or 1410 can provide programmable devices 1404a-1404e with access to software for database, search, computation, graphical, audio, video, World Wide Web/Internet utilization, and/or other functions. Many other examples of server devices are possible as well.

### Computing Device Architecture

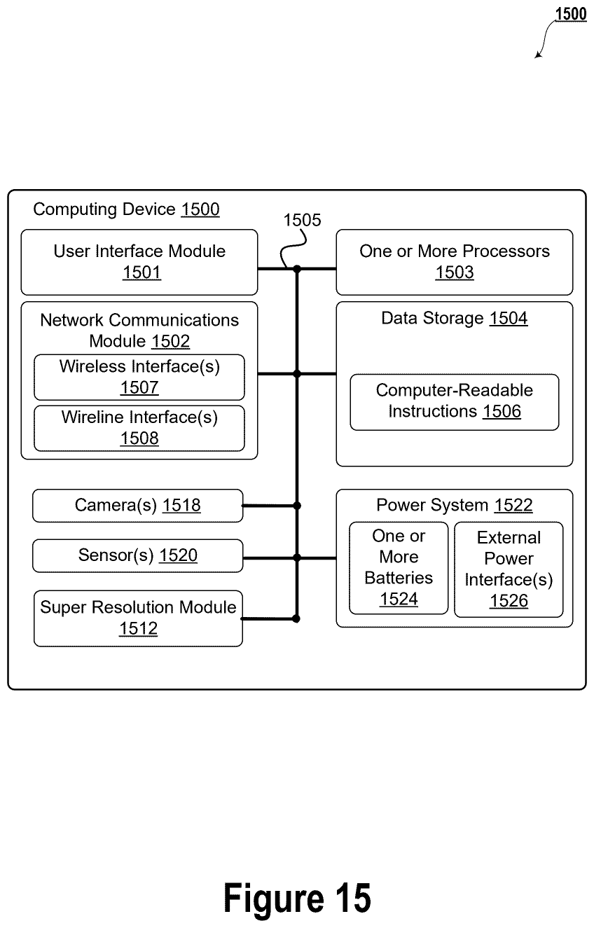

FIG. 15 is a block diagram of an example computing device 1500, in accordance with example embodiments. In particular, computing device 1500 shown in FIG. 15 can be configured to perform at least one function described herein, including methods 1600, and/or 1700.

Computing device 1500 may include a user interface module 1501, a network communications module 1502, one or more processors 1503, data storage 1504, one or more cameras 1518, one or more sensors 1520, and power system 1522, all of which may be linked together via a system bus, network, or other connection mechanism 1505.

User interface module 1501 can be operable to send data to and/or receive data from external user input/output devices. For example, user interface module 1501 can be configured to send and/or receive data to and/or from user input devices such as a touch screen, a computer mouse, a keyboard, a keypad, a touch pad, a trackball, a joystick, a voice recognition module, and/or other similar devices. User interface module 1501 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 1501 can also be configured to generate audible outputs, with devices such as a speaker, speaker jack, audio output port, audio output device, earphones, and/or other similar devices. User interface module 1501 can further be configured with one or more haptic devices that can generate haptic outputs, such as vibrations and/or other outputs detectable by touch and/or physical contact with computing device 1500. In some examples, user interface module 1501 can be used to provide a graphical user interface (GUI) for utilizing computing device 1500.

Network communications module 1502 can include one or more devices that provide one or more wireless interfaces 1507 and/or one or more wireline interfaces 1508 that are configurable to communicate via a network. Wireless interface(s) 1507 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 1508 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 1502 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 1503 can include one or more general purpose processors (e.g., central processing unit (CPU), etc.), and/or one or more special purpose processors (e.g., digital signal processors, tensor processing units (TPUs), graphics processing units (GPUs), application specific integrated circuits, etc.). One or more processors 1503 can be configured to execute computer-readable instructions 1506 that are contained in data storage 1504 and/or other instructions as described herein.

Data storage 1504 can include one or more non-transitory computer-readable storage media that can be read and/or accessed by at least one of one or more processors 1503. The one or more computer-readable storage media can include volatile and/or non-volatile storage components, such as optical, magnetic, organic, or other memory or disc storage, which can be integrated in whole or in part with at least one of one or more processors 1503. In some examples, data storage 1504 can be implemented using a single physical device (e.g., one optical, magnetic, organic, or other memory or disc storage unit) , while in other examples, data storage 1504 can be implemented using two or more physical devices.

Data storage 1504 can include computer-readable instructions 1506 and additional data. In some examples, data storage 1504 can include storage required to perform at least part of the herein-described methods, scenarios, and techniques and/or at least part of the functionality of the herein-described devices and networks. In particular, computer-readable instructions 1506 can include instructions that, when executed by processor(s) 1503, enable computing device 1500 to provide for some or all of the functionality described herein.

In some embodiments, computer-readable instructions 1506 can include instructions that, when executed by processor(s) 1503, enable computing device 1500 to conduct operations. The operations may include receiving, by a computing device, a plurality of video frames captured at a first resolution. The operations may also include applying a trained machine learning model to upscale the plurality of video frames to a second resolution, wherein the second resolution is higher than the first resolution. The operations may additionally include applying a gradient blending process to the upscaled plurality of video frames. The operations may also include providing the gradient blended and upscaled plurality of video frames.

In some embodiments, computer-readable instructions 1506 can include instructions that, when executed by processor(s) 1503, enable computing device 1500 to conduct operations. The operations may include receiving training data comprising a plurality of pairs, each pair comprising of a high resolution ground truth image and a corresponding low resolution version of the high resolution image, the corresponding low resolution version having been generated from the high resolution image by (a) performing downscaling and adding noise, and (b) applying a consistent degradation between the low resolution version and the high resolution ground truth image to reduce artifacts in low frequency portions of the low resolution version. The operations may also include training, based on the training data, a machine learning (ML) model to predict an upscaled version of a plurality of video frames captured at a first resolution, wherein the upscaled version is in a second resolution, and wherein the second resolution is higher than the first resolution. The operations may additionally include providing the trained ML model.

In some examples, computing device 1500 can include super resolution module 1512. Super resolution module 1512 can be configured to upscale the plurality of video frames to a second resolution, wherein the second resolution is higher than a first resolution for input video frames and apply a gradient blending process to the upscaled plurality of video frames. Also, for example, super resolution module 1512 can be configured to receive training data comprising a plurality of pairs, each pair comprising of a high resolution ground truth image and a corresponding low resolution version of the high resolution image, the corresponding low resolution version having been generated from the high resolution image by (a) performing downscaling and adding noise, and (b) applying a consistent degradation between the low resolution version and the high resolution ground truth image to reduce artifacts in low frequency portions of the low resolution version, and to train, based on the training data, a machine learning (ML) model to predict an upscaled version of a plurality of video frames captured at a first resolution, wherein the upscaled version is in a second resolution, and wherein the second resolution is higher than the first resolution.

In some examples, computing device 1500 can include one or more cameras 1518. Camera(s) 1518 can include one or more image capture devices, such as still and/or video cameras, equipped to capture light and record the captured light in one or more images; that is, camera(s) 1518 can generate image(s) of captured light. The one or more images can be one or more still images and/or one or more images utilized in video imagery. Camera(s) 1518 can capture light and/or electromagnetic radiation emitted as visible light, infrared radiation, ultraviolet light, and/or as one or more other frequencies of light. Camera(s) 1518 can include a wide camera, a tele camera, an ultrawide camera, and so forth. Also, for example, camera(s) 1518 can be front-facing or rear-facing cameras with reference to computing device 1500. Camera(s) 1518 can include camera components such as, but are not limited to, an aperture, shutter, recording surface (e.g., photographic film and/or an image sensor), lens, and/or shutter button. The camera components may be controlled at least in part by software executed by one or more processors 1503.

In some examples, computing device 1500 can include one or more sensors 1520. Sensors 1520 can be configured to measure conditions within computing device 1500 and/or conditions in an environment of computing device 1500 and provide data about these conditions. For example, sensors 1520 can include one or more of: (i) sensors for obtaining data about computing device 1500, such as, but not limited to, a thermometer for measuring a temperature of computing device 1500, a battery sensor for measuring power of one or more batteries of power system 1522, and/or other sensors measuring conditions of computing device 1500; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 1500, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 1500, such as, but not limited to, an infrared sensor, an optical sensor, a light sensor (e.g., an ambient light sensor), a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 1500, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 1520 are possible as well.

Power system 1522 can include one or more batteries 1524 and/or one or more external power interfaces 1526 for providing electrical power to computing device 1500. Each battery of the one or more batteries 1524 can, when electrically coupled to the computing device 1500, function as a source of stored electrical power for computing device 1500. One or more batteries 1524 of power system 1522 can be configured to be portable. Some or all of one or more batteries 1524 can be readily removable from computing device 1500. In other examples, some or all of one or more batteries 1524 can be internal to computing device 1500 and so may not be readily removable from computing device 1500. Some or all of one or more batteries 1524 can be rechargeable. For example, a rechargeable battery can be recharged via a wired connection between the battery and another power supply, such as by one or more power supplies that are external to computing device 1500 and connected to computing device 1500 via the one or more external power interfaces. In other examples, some or all of one or more batteries 1524 can be non-rechargeable batteries.

One or more external power interfaces 1526 of power system 1522 can include one or more wired-power interfaces, such as a USB cable and/or a power cord, that enable wired electrical power connections to one or more power supplies that are external to computing device 1500. One or more external power interfaces 1526 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 1526, computing device 1500 can draw electrical power from the external power source the established electrical power connection. In some examples, power system 1522 can include related sensors, such as battery sensors associated with the one or more batteries or other types of electrical power sensors.

One or more external power interfaces 1526 of power system 1522 can include one or more wired-power interfaces, such as a USB cable and/or a power cord, that enable wired electrical power connections to one or more power supplies that are external to computing device 1500. One or more external power interfaces 1526 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 1526, computing device 1500 can draw electrical power from the external power source the established electrical power connection. In some examples, power system 1522 can include related sensors, such as battery sensors associated with the one or more batteries or other types of electrical power sensors.

### Example Methods of Operation

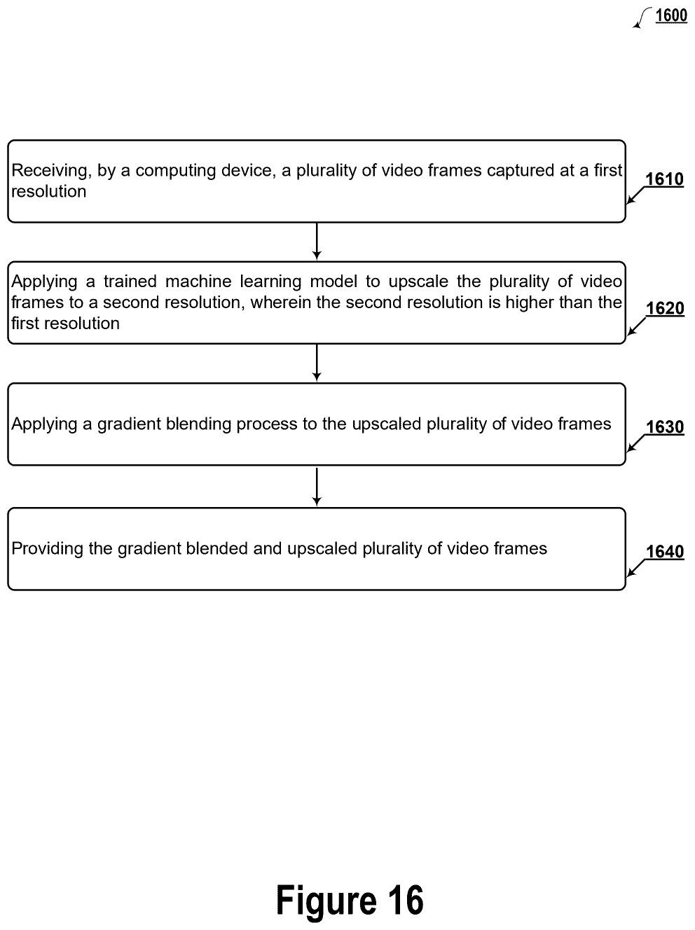

FIG. 16 is a flowchart of a method, in accordance with example embodiments. Method 1600 may include various blocks or steps. The blocks or steps may be conducted individually or in combination. The blocks or steps may be conducted in any order and/or in series or in parallel. Further, blocks or steps may be omitted or added to method 1600.

The blocks of method 1600 may be conducted by various elements of computing device 1500 as illustrated and described in reference to FIG. 15.

Block 1610 involves receiving, by a computing device, a plurality of video frames captured at a first resolution.

Block 1620 involves applying a trained machine learning model to upscale the plurality of video frames to a second resolution, wherein the second resolution is higher than the first resolution.

Block 1630 involves applying a gradient blending process to the upscaled plurality of video frames.

Block 1640 involves providing the gradient blended and upscaled plurality of video frames.

In some embodiments, the trained machine learning model may be a Generative Adversarial Network (GAN) model.

In some embodiments, applying the gradient blending process involves generating a spatially varying alpha map based on image gradients.

In some embodiments, applying the gradient blending process involves utilizing the spatially varying alpha map to combine the upscaled plurality of video frames with a reference frame.

In some embodiments, the alpha map may be clamped between a minimum and maximum value.

Some embodiments involve applying a low-frequency replace process to align the output with the input brightness and color.

Some embodiments involve identifying one or more regions of interest (ROIs) in the plurality of video frames. Such embodiments involve applying an image enhancement to the identified one or more ROIs.

In some embodiments, identifying the one or more ROIs involves detecting text regions in the plurality of video frames, and applying the image enhancement to the identified one or more ROIs involves applying a text super-resolution module to enhance the text in the detected text regions.

In some embodiments, the identified one or more ROIs include one or more of a face, a pet, or another recognizable object of interest.

In some embodiments, the first resolution is 4 K and the second resolution is 8 K.

In some embodiments, applying the gradient blending process reduces temporal flickers in high frequency areas.

In some embodiments, the method may be performed by the computing device including one or more processors and a super resolution upscaler.

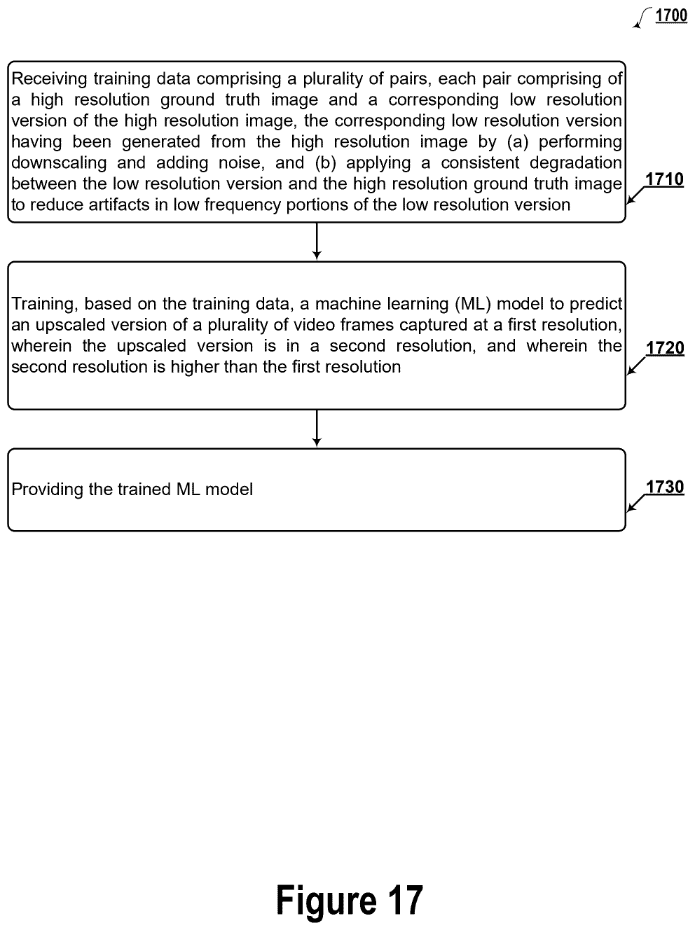

FIG. 17 is another flowchart of a method, in accordance with example embodiments. Method 1700 may include various blocks or steps. The blocks or steps may be conducted individually or in combination. The blocks or steps may be conducted in any order and/or in series or in parallel. Further, blocks or steps may be omitted or added to method 1700.

The blocks of method 1700 may be conducted by various elements of computing device 1500 as illustrated and described in reference to FIG. 15.

Block 1710 involves receiving training data comprising a plurality of pairs, each pair comprising of a high resolution ground truth image and a corresponding low resolution version of the high resolution image, the corresponding low resolution version having been generated from the high resolution image by (a) performing downscaling and adding noise, and (b) applying a consistent degradation between the low resolution version and the high resolution ground truth image to reduce artifacts in low frequency portions of the low resolution version.

Block 1720 involves training, based on the training data, a machine learning (ML) model to predict an upscaled version of a plurality of video frames captured at a first resolution, wherein the upscaled version is in a second resolution, and wherein the second resolution is higher than the first resolution.

Block 1730 involves providing the trained ML model.

In some embodiments, the consistent degradation involves performing downscaling and adding noise to generate the low-resolution version.

In some embodiments, adding noise comprises adding sensor-level noise based on a recorded noise model.

In some embodiments, the training data augmentation involves randomly adding Gaussian noise.

In some embodiments, the training data augmentation involves applying random hue, saturation, gamma, brightness, and contrast adjustments.

In some embodiments, the training data augmentation involves adding random JPEG compression noise.

In some embodiments, the machine learning model may be trained using a modified loss function including RGB_L1_Unsharp, VGG_loss, and Relativistic_Discriminator_loss.

In some embodiments, the machine learning model is trained using a modified loss function including YUV_L1, VGG_Unsharp_loss, and Relativistic_Discriminator_loss.

In some embodiments, the low-resolution version may be generated by cropping a high-resolution raw image to correspond to an RGGB Bayer order and have dimensions that are integer multiples of the downscaling factor.

In some embodiments, the low-resolution version may be generated by converting the high-resolution raw image to 14-bit unsigned levels before subsampling.

In some embodiments, the consistent degradation aims to prevent the trained ML model from hallucinating details in low-frequency regions of the image.

In some embodiments, generating the low-resolution version by performing downscaling and adding noise includes adding additional noise based on a randomly sampled noise-model from camera noise-model overrides.

In some embodiments, the training data augmentation includes adding random Gaussian noise after a paired-HDR+ call with a specified probability and random sigma.

In some embodiments, the training data augmentation includes randomly rotating the image pairs.

In some embodiments, the training data augmentation includes randomly applying vertical and horizontal flips to the image pairs.

In some embodiments, the training data augmentation during training includes adjusting one or more of random hue, saturation, gamma, brightness, or contrast.

In some embodiments, the training data augmentation during training includes adding random Gaussian noise in the YUV domain.

In some embodiments, the training data augmentation during training includes adding random JPEG compression noise with a specified quality range.

In some embodiments, the training data may be generated by subsampling raw-image sets from a high-resolution burst collection.

In some embodiments, the training data may be generated by downscaling individual raw-images from a high-resolution raw image set to generate lower resolution raw images.

In some embodiments, the high-resolution raw image may be cropped to correspond to an RGGB Bayer order and have dimensions that are integer multiples of the downscaling factor.

In some embodiments, the high-resolution raw image may be converted to 14-bit unsigned levels before subsampling.

Some embodiments involve filtering out training data crops with anomalously high L1 difference between the upscaled low-resolution crop and the high-resolution crop.

Some embodiments involve decreasing the probability of selecting training data crops with an average L1 difference smaller than a threshold value.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively, or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random-access memory (RAM). The computer readable media can also include non-transitory computer readable media that store program code and/or data for longer periods. Thus, the computer readable media may include secondary or persistent long-term storage, like read only memory (ROM), optical or magnetic disks, compact disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A computer-implemented method, comprising:
receiving, by a computing device, a plurality of video frames captured at a first resolution;
applying a trained machine learning model to upscale the plurality of video frames to a second resolution, wherein the second resolution is higher than the first resolution;
applying a gradient blending process to the upscaled plurality of video frames; and
providing the gradient blended and upscaled plurality of video frames.

2. The method of claim 1, wherein the trained machine learning model is a Generative Adversarial Network (GAN) model.

3. The method of claim 1, wherein the applying of the gradient blending process further comprising:
generating a spatially varying alpha map based on image gradients; and
utilizing the spatially varying alpha map to combine the upscaled plurality of video frames with a reference frame.

4. The method of claim 3, wherein the alpha map is clamped between a minimum and maximum value.

5. The method of claim 1, further comprising:
applying a low-frequency replace process to align the output with the input brightness and color.

6. The method of claim 1, further comprising:
identifying one or more regions of interest (ROIs) in the plurality of video frames; and
applying an image enhancement to the identified one or more ROIs.

7. The method of claim 6, wherein:
identifying the one or more ROIs comprises detecting text regions in the plurality of video frames, and
applying the image enhancement to the identified one or more ROIs comprises applying a text super-resolution module to enhance the text in the detected text regions.

8. The method of claim 6, wherein the identified one or more ROIs comprises one or more of a face, a pet, or another recognizable object of interest.

9. A computer-implemented method, comprising:
receiving training data comprising a plurality of pairs, each pair comprising of a high resolution ground truth image and a corresponding low resolution version of the high resolution image, the corresponding low resolution version having been generated from the high resolution image by (a) performing downscaling and adding noise, and (b) applying a consistent degradation between the low resolution version and the high resolution ground truth image to reduce artifacts in low frequency portions of the low resolution version;
training, based on the training data, a machine learning (ML) model to predict an upscaled version of a plurality of video frames captured at a first resolution, wherein the upscaled version is in a second resolution, and wherein the second resolution is higher than the first resolution; and
providing the trained ML model.

10. The method of claim 9, wherein the consistent degradation comprises performing downscaling and adding noise to generate the low-resolution version.

11. The method of claim 9, wherein adding noise comprises adding sensor-level noise based on a recorded noise model.

12. The method of claim 9, wherein the training data augmentation further comprises one or more of (i) randomly adding Gaussian noise, (ii) applying random hue, saturation, gamma, brightness, and contrast adjustments, or (iii) adding random JPEG compression noise.

13. The method of claim 9, wherein the machine learning model is trained using one of (i) a modified loss function including RGB_L1_Unsharp, VGG_loss, and Relativistic_Discriminator_loss or (ii) a modified loss function including YUV_L1, VGG_Unsharp_loss, and Relativistic_Discriminator_loss.

14. The method of claim 9, wherein the low-resolution version is generated by one or more of (i) cropping a high-resolution raw image to correspond to an RGGB Bayer order and have dimensions that are integer multiples of the downscaling factor, or (ii) converting the high-resolution raw image to 14-bit unsigned levels before subsampling.

15. The method of claim 9, wherein generating the low-resolution version by performing downscaling and adding noise comprises adding additional noise based on a randomly sampled noise-model from camera noise-model overrides.

16. The method of claim 9, wherein the training data augmentation comprises one or more of (i) adding random Gaussian noise after a paired-HDR+ call with a specified probability and random sigma, (ii) randomly rotating the image pairs, or (iii) randomly applying vertical and horizontal flips to the image pairs.

17. The method of claim 9, wherein the training data augmentation during training comprises one or more of (i) adjusting at least a random hue, saturation, gamma, brightness, or contrast, (ii) adding random Gaussian noise in the YUV domain, or (iii) adding random JPEG compression noise with a specified quality range.

18. The method of claim 9, wherein the training data is generated by one or more of (i) subsampling raw-image sets from a high-resolution burst collection, or (ii) downscaling individual raw-images from a high-resolution raw image set to generate lower resolution raw images.

19. The method of claim 9, further comprising:
filtering out training data crops with anomalously high L1 difference between the upscaled low-resolution crop and the high-resolution crop.

20. A computing device, comprising:
one or more processors; and
data storage, wherein the data storage has stored thereon computer-executable instructions that, when executed by the one or more processors, cause the computing device to perform functions comprising:
receiving, by a computing device, a plurality of video frames captured at a first resolution;
applying a trained machine learning model to upscale the plurality of video frames to a second resolution, wherein the second resolution is higher than the first resolution;
applying a gradient blending process to the upscaled plurality of video frames; and
providing the gradient blended and upscaled plurality of video frames.
